(19) United States
(12) Patent Application Publication
(10) Pub. No.: US 2011/0227301 A1
(43) Pub. Date: Sep. 22, 2011

(54) Vehicle Height Adjusting Apparatus

(75) Inventors: Osamu Nagai, Shizuoka (JP); Hiromichi Matsuura, Shizuoka (JP)

(73) Assignee: SHOWA CORPORATION, Saitama (JP)

(21) Appl. No.: 13/017,901

(22) Filed: Jan. 31, 2011

Related U.S. Application Data
(63) Continuation-in-part of application No. 12/725,372, filed on Mar. 16, 2010.

(30) Foreign Application Priority Data
Jul. 29, 2010 (JP) 2010-171179

(51) Int. Cl. B60G 17/04

(52) U.S. Cl. 280/6.157

(57) ABSTRACT

A vehicle height adjusting apparatus of a hydraulic shock absorber has a hydraulic pump carrying out a pumping action by an extending and retracting motion of a piston rod with respect to a damper tube so as to feed a working fluid to a jack chamber of a hydraulic jack, and a blow valve releasing a jack pressure of the jack chamber which is pressurized by a plunger of the hydraulic jack exposed to a spring load on a suspension spring.

### BACKGROUND OF THE INVENTION

1. Field of the Invention

The present invention relates to a vehicle height adjusting apparatus.

2. Description of the Related Art

As a vehicle height adjusting apparatus, as described in Japanese Patent Application Laid-Open No. 9-89034 (Patent Document 1), there is a vehicle height adjusting apparatus with an automatic level adjusting function, which is provided with a cylinder arranged within an outer shell, a hollow piston rod having a piston inserted into the cylinder, a pump rod supported by a base valve fixed to the cylinder and communicating with a reservoir via a hollow hole provided in an axial direction in a hollow space of the piston rod, and a pump cylinder accommodating the pump rod and installing a discharge valve for actuating a jack up cylinder at an end portion thereof, wherein the piston divides inside of the cylinder into a rod side chamber and a non-rod side chamber, the pump cylinder is provided with a notch passage for communicating a pump chamber within the pump cylinder with the non-rod side chamber and a control orifice for communicating a pressure chamber of the jack up cylinder with the pump chamber within the pump cylinder at a corresponding actuating position of the piston, and a suction valve is arranged at an end portion of the pump rod.

This conventional vehicle height adjusting apparatus is interposed between a vehicle body of a vehicle and an axle and attenuates oscillation from a road surface, and can control a vehicle height to be always at a fixed value regardless of a load on a spring.

The vehicle height adjusting apparatus described in Patent Document 1 is provided with the notch passage and the control orifice in the pump cylinder inserted between the hollow portion of the piston rod and the pump rod, and controls feeding and discharge of a working fluid pressure-fed by the pump chamber to the hydraulic jack by means of the notch passage and the control orifice of the pump cylinder.

Accordingly, in the vehicle height adjusting apparatus described in Patent Document 1, the pump cylinder provided with the notch passage and the control orifice is necessary, and the pump cylinder is interposed between the piston rod and the pump rod. As a result, a rod diameter of the piston rod is increased, which makes an outer diameter of the cylinder to which the piston rod is inserted larger, and there is a difficulty in a layout for attaching the apparatus to the vehicle.

An object of the present invention is to construct a compact vehicle height adjusting apparatus of a hydraulic shock absorber that is provided between a vehicle body and an axle so as to attenuate oscillation from a road surface, and control a vehicle height to be always at a fixed value regardless of a spring load on a suspension spring.

Further, the vehicle height adjusting apparatus of the hydraulic shock absorber is a structure such that the hydraulic pump is built in the damper tube, and the working fluid in the oil chamber within the damper tube is sucked into the pump chamber. Accordingly, if the hydraulic shock absorber is placed vertically or the vehicle body is raised up after the hydraulic shock absorber is mounted, air of the oil reservoir chamber intrudes into the oil chamber due to the horizontal storage of the hydraulic shock absorber, or the inversion of the vehicle body when the hydraulic shock absorber is mounted to the vehicle body, there is a risk that the air reservoir in the upper portion of the oil chamber is sucked into the pump chamber from the suction port of the hydraulic pump. In the case mentioned above, even if the hydraulic pump carries out the pumping motion in accordance with the extension and retraction of the hydraulic shock absorber, it only compresses the air within the pump chamber, and the pressure feeding of the oil to the hydraulic jack can not be achieved.

Another object of the invention is to prevent the air from being sucked into the pump chamber of the hydraulic pump, even if the above air in the oil reservoir chamber intrudes into the oil chamber due to horizontal storage of the hydraulic shock absorber or the like.

### SUMMARY OF THE INVENTION

In a first aspect of the invention, there is provided a vehicle height adjusting apparatus of a hydraulic shock absorber comprising: a damper tube provided on one of a vehicle body side and an axle side; a piston rod provided on the other of the vehicle body side and the axle side, and sliding along an oil chamber within the damper tube so as to extend and retract with respect to the damper tube; a hydraulic jack provided in one of a damper tube and a piston rod; and a suspension spring interposed between a spring receiver supported by a plunger inserted to a jack chamber of the hydraulic jack and a spring receiver provided on the other side of the damper tube and the piston rod. The vehicle height adjusting apparatus further comprising: a hydraulic pump carrying out a pumping action by an extending and retracting motion of the piston rod with respect to the damper tube so as to feed a working fluid to the jack chamber of the hydraulic jack; and a blow valve releasing a jack pressure of the jack chamber pressurized by the plunger of the hydraulic jack exposed to a spring load on the suspension spring. In a range in which a damper sagging stroke corresponding to an amount of displacement from an extending end of the piston rod is small and the vehicle height is high, it is set such that the jack pressure becomes smaller and a valve opening pressure of the blow valve becomes smaller than the jack pressure as the vehicle height becomes higher, whereby the blow valve is opened to release the jack pressure which the hydraulic pump feeds to the hydraulic jack so as to bring down the vehicle height, and in a range in which the damper sagging stroke is large and the vehicle height is low, it is set such that the jack pressure becomes larger and the valve opening pressure of the blow valve becomes larger than the jack pressure as the vehicle height becomes lower, whereby the blow valve is closed to stop the release of the jack pressure which the hydraulic pump feeds to the hydraulic jack so as to bring up the vehicle height.

In accordance with the present invention, the following operations and effects can be obtained.

(a) In a range in which the spring load on the suspension spring is reduced by unloading goods from a vehicle in the standard vehicle height state, for example, the damper (the hydraulic shock absorber) is extended, the damper sagging stroke St corresponding to the amount of displacement from the extending end of the piston rod becomes small, and the vehicle height becomes higher than the standard vehicle height, it is set such that the jack pressure Pa becomes smaller and the valve opening pressure Pb of the blow valve becomes smaller than the jack pressure Pa as the vehicle height becomes higher. At this time, the jack pressure Pa is released by opening the blow valve, and the vehicle height is lowered to the standard vehicle height.

(b) In a range in which the spring load on the suspension spring is increased by loading goods to a vehicle in the standard vehicle height state, for example, the damper sags, the damper sagging stroke St becomes large, and the vehicle height becomes lower than the standard vehicle height, it is set such that the jack pressure Pa becomes larger and the valve opening pressure Pb of the blow valve becomes larger than the jack pressure Pa as the vehicle height becomes lower. At this time, if the hydraulic shock absorber is excited by the irregularity of the road surface while the vehicle travels, and the hydraulic pump carries out the pumping action, the release of the jack pressure Pa which the hydraulic pump feeds to the hydraulic jack to the side of the piston rod side oil chamber is stopped by closing the blow valve, and the vehicle height is brought up to the standard vehicle height.

(c) According to the vehicle height adjusting apparatus having the simple and compact structure in which the jack pressure Pa of the hydraulic jack and the valve opening pressure Pb of the blow valve are set so as to satisfy the relationships (a) and (b) mentioned above with respect to the damper sagging stroke St, the vehicle height can be controlled to be always at a fixed value regardless of the spring load on the suspension spring.

In a second aspect of the invention, there is provided the vehicle height adjusting apparatus of a hydraulic shock absorber according to the first aspect, wherein the hydraulic shock absorber is provided with an end piece which comparts the chamber within the damper tube and the jack chamber of the hydraulic jack, in a bottom portion of the damper tube, and has the hydraulic pump and the blow valve in the damper tube. The hydraulic pump slidably inserts a hollow pipe provided in a rising manner in the end piece of the damper tube to a hollow portion of the piston rod, forms a pump chamber by the hollow portion of the piston rod and the hollow pipe, is provided with a discharge check valve in a discharge passage discharging the working fluid in the pump chamber pressurized by a retraction motion of the piston rod to a side of the hydraulic jack, and is provided with a suction check valve in a suction passage sucking the working fluid in the oil chamber within the damper tube to the pump chamber which comes to a negative pressure on the basis of an extension motion of the piston rod. The blow valve is provided in the end piece so as to open and close a blow passage which is formed in the end piece of the damper tube and guides the discharge passage between the pump chamber and the jack chamber to the oil chamber within the damper tube, and is biased in a closing direction by biasing means which is interposed between the blow valve and the piston rod.

In accordance with the present invention, the following operations and effects can be obtained.

(d) The hydraulic shock absorber described in the above (a) to (c) has the blow valve releasing the jack pressure Pa in the jack chamber which is pressurized by the plunger of the hydraulic jack exposed to the spring load on the suspension spring. In this case, the blow valve is provided in the end piece of the damper tube in such a manner as to open and close the blow passage which is formed in the end piece and leads the discharge passage between the pump chamber and the jack chamber to the oil chamber in the damper tube, and is biased in the closing direction by the biasing means interposed between the blow valve and the piston rod. Accordingly, it is possible to control the vehicle height to be always at a fixed value regardless of the spring load on the suspension spring, according to the simple and compact structure in which the spring characteristic of the suspension spring pushing down the plunger of the hydraulic jack and the spring characteristic of the biasing means biasing the blow valve in the closing direction are set in such a manner that the jack pressure Pa of the hydraulic jack and the valve opening pressure Pb of the blow valve satisfy the relationships (a) and (b) mentioned above with respect to the damper sagging stroke.

In a third aspect of the invention, there is provided the vehicle height adjusting apparatus of a hydraulic shock absorber according to the first aspect, wherein the hydraulic pump arranges a suction port which is open to the oil chamber within the damper tube at a lower position than a lower end portion of the piston rod at the damper maximum compression time, in a lower end side of the hollow pipe.

In accordance with the present invention, the following operations and effects can be obtained.

(e) The hydraulic pump built in the damper tube of the hydraulic shock absorber in the item (d) mentioned above arranges the suction port which is open to the oil chamber within the damper tube at the lower position than the lower end portion of the piston rod at a time of the maximum compression of the damper, in the lower end side of the hollow pipe. If the hydraulic shock absorber is vertically placed or the vehicle body is raised up, after the hydraulic shock absorber is horizontally placed or inverted together with the vehicle body, and the air in the oil reservoir chamber intrudes into the oil chamber, the intruding air collects in the lower portion of the piston within the oil chamber. The air moves to the upper portion of the piston through the oil path of the piston on the basis of the extension and retraction of the hydraulic shock absorber, and is discharged to the oil reservoir chamber from the sliding gap between the piston rod and the rod guide.

On the other hand, the suction port of the hydraulic pump is arranged at the lower position than the lower end portion of the piston rod at a time of the maximum compression of the damper, in the lower end side of the hollow pipe, and is always submerged in the oil. Accordingly, it is possible to exclude the chance that the air intruding into the oil chamber of the hydraulic shock absorber is sucked into the suction port of the hydraulic pump, so that it is possible to prevent the air from being sucked into the pump chamber. It is possible to stably pressure feed the oil in the pump chamber to the hydraulic jack, on the basis of the pumping motion of the hydraulic pump in accordance with the extension and retraction of the hydraulic shock absorber.

In a fourth aspect of the invention, there is provided a vehicle height adjusting apparatus comprising first and second hydraulic shock absorbers arranged in line, the first hydraulic shock absorber comprising: a damper tube provided in one of a vehicle body side and an axle side; a piston rod provided in the other of the vehicle body side and the axle side, and sliding along an oil chamber within the damper tube so as to extend and retract with respect to the damper tube; a hydraulic jack provided in one of a damper tube and a piston rod; and a suspension spring interposed between a spring receiver supported by a plunger inserted to a jack chamber of the hydraulic jack and a spring receiver provided on the other side of the damper tube and the piston rod. The second hydraulic shock absorber comprising: a damper tube provided on one of the vehicle body side and the axle side; a piston rod provided in the other of the vehicle body side and the axle side, and sliding along the oil chamber within the damper tube so as to extend and retract with respect to the damper tube; a hydraulic pump carrying out a pumping action by an extending and retracting motion of the piston rod with respect to the damper tube so as to feed a working fluid to the jack chamber in the hydraulic jack of the first hydraulic shock absorber; and a blow valve releasing the jack pressure of the jack chamber which is pressurized by the plunger of the hydraulic jack exposed to the spring load on the suspension spring in the first hydraulic shock absorber. In a range in which a damper sagging stroke corresponding to an amount of displacement from an extending end of the piston rod of the first hydraulic shock absorber is small and the vehicle height is high, it is set such that the jack pressure of the first hydraulic shock absorber becomes smaller and a valve opening pressure of the blow valve of the second hydraulic shock absorber becomes smaller than the jack pressure as the vehicle height becomes higher, whereby the blow valve is opened to release the jack pressure which the hydraulic pump of the second hydraulic shock absorber feeds to the hydraulic jack of the first hydraulic shock absorber so as to bring down the vehicle height, and in a range in which the damper sagging stroke of the first hydraulic shock absorber is large and the vehicle height is low, it is set such that the jack pressure of the first hydraulic shock absorber becomes larger and the valve opening pressure of the blow valve of the second hydraulic shock absorber becomes larger than the jack pressure as the vehicle height becomes lower, whereby the blow valve is closed to stop the release of the jack pressure which the hydraulic pump of the second hydraulic shock absorber feeds to the hydraulic jack of the first hydraulic shock absorber so as to bring up the vehicle height.

In accordance with the present invention, the following operations and effects can be obtained.

(f) In a range in which the spring load on the suspension spring of the first hydraulic shock absorber is reduced by unloading goods from the vehicle in the standard vehicle height state, for example, the damper (the hydraulic shock absorber) is extended, the damper sagging stroke St corresponding to the amount of displacement from the extending end of the piston rod of the first hydraulic shock absorber becomes small, and the vehicle height becomes higher than the standard vehicle height, it is set such that the jack pressure Pa of the first hydraulic shock absorber becomes smaller and the valve opening pressure Pb of the blow valve of the second hydraulic shock absorber becomes smaller than the jack pressure Pa as the vehicle height becomes higher. At this time, if the second hydraulic shock absorber is excited by the irregularity of the road surface while the vehicle travels, and the hydraulic pump of the second hydraulic shock absorber carries out the pumping action, the jack pressure Pa which the hydraulic pump feeds to the hydraulic jack of the first hydraulic shock absorber is released by opening the blow valve of the second hydraulic shock absorber, and the vehicle height is brought down to the standard vehicle height.

(g) In a range in which the spring load on the suspension spring of the first hydraulic shock absorber is increased by loading goods to a vehicle in the standard vehicle height state, for example, the damper sags, the damper sagging stroke St of the first hydraulic shock absorber becomes large, and the vehicle height becomes lower than the standard vehicle height, it is set such that the jack pressure Pa of the first hydraulic shock absorber becomes larger, and the valve opening pressure Pb of the blow valve of the second hydraulic shock absorber becomes larger than the jack pressure Pa as the vehicle height becomes lower. At this time, if the second hydraulic shock absorber is excited by the irregularity of the road surface while the vehicle travels, and the hydraulic pump of the second hydraulic shock absorber carries out the pumping action, the release of the jack pressure Pa which the hydraulic pump feeds to the hydraulic jack of the first hydraulic shock absorber is stopped by closing the blow valve of the second hydraulic shock absorber, and the vehicle height is brought up to the standard vehicle height.

(h) According to the vehicle height adjusting apparatus having the simple and compact structure in which the jack pressure Pa of the hydraulic jack of the first hydraulic shock absorber and the valve opening pressure Pb of the blow valve of the second hydraulic shock absorber are set so as to satisfy the relationships (f) and (g) mentioned above with respect to the damper sagging stroke St, the vehicle height can be controlled to be always at a fixed value regardless of the spring load on the suspension spring of the first hydraulic shock absorber.

In a fifth aspect of the invention, there is provided the vehicle height adjusting apparatus according to the forth aspect, wherein the second hydraulic shock absorber is structured such that an end housing is attached to an end portion of the damper tube, and has the hydraulic pump and the blow valve built-in in the damper tube. The hydraulic pump is a slidably inserted hollow pipe provided upright in the end housing of the damper tube to a pump chamber formed by a hollow portion of the piston rod, and has a discharge check valve provided in a discharge passage discharging the working fluid in the pump chamber, pressurized due to a retracting motion of the piston rod, to a side of the hydraulic jack of the first hydraulic shock absorber, and a sucking check valve provided in a suction passage sucking the working fluid in the damper tube to the pump chamber becoming a negative pressure as a result of an extending motion of the piston rod. The blow valve is provided in the end housing in such a manner as to open and close a blow passage which is formed in the end housing of the damper tube and leads the discharge passage between the pump chamber and the jack chamber of the first hydraulic shock absorber to the oil chamber in the damper tube, and is biased in a closing direction by biasing means interposed between the blow valve and the piston rod.

In accordance with the present invention, the following operations and effects can be obtained.

(i) The second hydraulic shock absorber described in the above (f) to (h) has the blow valve releasing the jack pressure Pa in the jack chamber which is pressurized by the plunger of the hydraulic jack exposed to the spring load on the suspension spring in the first hydraulic shock absorber. In this case, the blow valve of the second hydraulic shock absorber is provided in the end housing of the damper tube in such a manner as to open and close the blow passage which is formed in the end housing and leads the discharge passage between the pump chamber and the jack chamber of the first hydraulic shock absorber to the oil chamber in the damper tube, and is biased in the closing direction by the biasing means interposed between the blow valve and the piston rod. Accordingly, it is possible to control the vehicle height to be always at a fixed value regardless of the spring load on the suspension spring of the first hydraulic shock absorber, according to the simple and compact structure in which the spring characteristic of the suspension spring pushing down the plunger of the hydraulic jack of the first hydraulic shock absorber and the spring characteristic of the biasing means biasing the blow valve of the second hydraulic shock absorber in the closing direction are set in such a manner that the jack pressure Pa of the hydraulic jack of the first hydraulic shock absorber and the valve opening pressure Pb of the blow valve of the second hydraulic shock absorber satisfy the relationships (f) and (g) mentioned above with respect to the damper sagging stroke.

In a sixth aspect of the invention, there is provided the vehicle height adjusting apparatus according to the first to fifth aspects, wherein the damper tube is provided with an oil return passage returning the working fluid in the jack chamber into the damper tube, when the plunger reaches a protruding end protruding from the jack chamber based on the working fluid fed to the jack chamber of the hydraulic jack.

In accordance with the present invention, the following operations and effects can be obtained.

(j) There is provided in the damper tube the oil return passage returning the working fluid in the jack chamber into the damper tube when the plunger reaches the protruding end at which the plunger protrudes from the jack chamber due to the working fluid fed to the jack chamber of the hydraulic jack. Accordingly, it is possible to avoid an unnecessary rise of the jack pressure Pa of the hydraulic jack, and it is possible to protect a sealing function of the hydraulic system.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a cross sectional view showing a vehicle height adjusting apparatus according to an embodiment 1;

FIG. 2 is a cross sectional view showing a damper tube in FIG. 1;

FIG. 3 is a cross sectional view of an upper portion of FIG. 2;

FIG. 4 is a cross sectional view of a lower portion of FIG. 2;

FIG. 5 is a graph showing a relationship between a jack pressure and a valve opening pressure of a blow valve;

FIG. 6 is a cross sectional view showing a vehicle height adjusting apparatus according to an embodiment 2;

FIG. 7 is a cross sectional view showing a damper tube in FIG. 6;

FIG. 8 is a cross sectional view of an upper portion of FIG. 7;

FIG. 9 is a cross sectional view of a lower portion of FIG. 7;

FIG. 10A is a side elevational view and FIG. 10B is a plan view showing a spring joint;

FIG. 11 is a cross sectional view showing a vehicle height adjusting apparatus according to an embodiment 3;

FIG. 12 is a cross sectional view showing a first hydraulic shock absorber;

FIG. 13 is a cross sectional view showing a damper tube in FIG. 12;

FIG. 14 is a cross sectional view showing a second hydraulic shock absorber;

FIG. 15 is a cross sectional view showing a damper tube in FIG. 14;

FIG. 16 is a cross sectional view of a lower portion of FIG. 15;

FIG. 17 is a cross sectional view of an upper portion of FIG. 15;

FIG. 18 is a graph showing a relationship between a jack pressure and a valve opening pressure of a blow valve;

FIG. 19 is a cross sectional view showing a vehicle height adjusting apparatus according to an embodiment 4;

FIG. 20 is a cross sectional view showing a damper tube in FIG. 19;

FIG. 21 is a cross sectional view of an upper portion in FIG. 20;

FIG. 22 is a cross sectional view of a lower portion in FIG. 20; and

FIG. 23 is a cross sectional view showing a suction state of a pump in a right half portion and showing a discharge state of the pump in a left half portion.

### DESCRIPTION OF THE PREFERRED EMBODIMENTS

### Embodiment 1

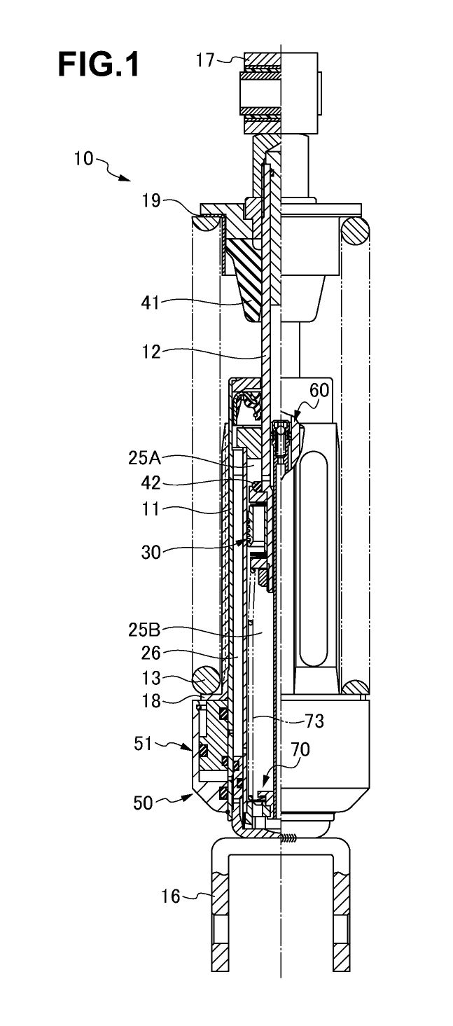

### FIGS. 1 to 5

A hydraulic shock absorber 10 constitutes a rear wheel suspension apparatus interposed between a rear axle side and a vehicle body side of a motor cycle, for example, and has a damper tube 11 attached to the axle side, a piston rod 12 attached to the vehicle body side and sliding via a piston 24 within the damper tube 11 so as to extend and retract with respect to the damper tube 11, and a suspension spring 13 arranged along an outer periphery of the damper tube 11 and the piston rod 12, as shown in FIGS. 1 to 4.

An axle side attaching member 16 is fixed to a bottom cup 15 at a bottom of the damper tube 11. A vehicle body side attaching member 17 is fixed to an upper end portion of the piston rod 12.

An outer peripheral portion on a lower end side of the damper tube 11 is equipped with a spring receiver 18 supported by a plunger 55 inserted to a jack chamber 54 of a hydraulic jack 51 of a vehicle height adjusting apparatus 50, which will be described later, the piston rod 12 is equipped with a spring receiver 19 supported by the vehicle body side attaching member 17, an upper end of the suspension spring 13 is supported by the spring receiver 19, and a lower end of the suspension spring is supported by the spring receiver 18. the spring receiver 18 is provided with a spring guide 18A.

The hydraulic shock absorber 10 is structured such that the damper tube 11 is formed as a double tube constructed by an inner tube 21 and an outer tube 22, a lower end of the inner tube 21 is inserted and fixed in a liquid tight manner to an inner periphery of the bottom cup 15 via an O-ring or the like, and a lower end of the outer tube 22 is inserted and fixed in a liquid tight manner to an outer periphery of the bottom cup 15 via a seal such as an O-ring or the like. The piston rod 12 is penetrated through and supported by a rod guide 23 that is fixed to an opening end of the inner tube 21 and the outer tube 22, and the piston 24 is provided so as to be fixed to an insertion end of the piston rod 12 to the inner tube 21. The hydraulic shock absorber 10 is structured such that a piston rod side oil chamber 25A and a piston side oil chamber 25B which are separated by the piston 24 are formed inside the inner tube 21, an annular gap between the inner tube 21 and the outer tube 22 is formed as an oil reservoir chamber 26, and a working fluid is charged into the oil chambers 25A and 25B and the oil reservoir chamber 26. The oil reservoir chamber 26 accommodates the working fluid and sets its upper portion as an air chamber. The oil reservoir chamber 26 is always communicated with the piston side oil chamber 25B through a communication hole 27 provided on a lower end side (a side of the axle) of the inner tube 21, and compensates for a working fluid of an amount corresponding to a volumetric capacity of the piston rod 12 moving into and out of the inner tube 21 with the extension and retraction of the hydraulic shock absorber 10.

The hydraulic shock absorber 10 is provided with a piston valve apparatus 30 in the piston 24, which allows the piston rod side oil chamber 25A and the piston side oil chamber 25B to be communicated and constitutes a damping force generating apparatus. The hydraulic shock absorber 10 attenuates an extending and retracting oscillation of the damper tube 11 and the piston rod 12 caused by an absorption of a shock force from a road surface by the suspension spring 13, by means of the damping force generating apparatus constituted by the piston valve apparatus 30.

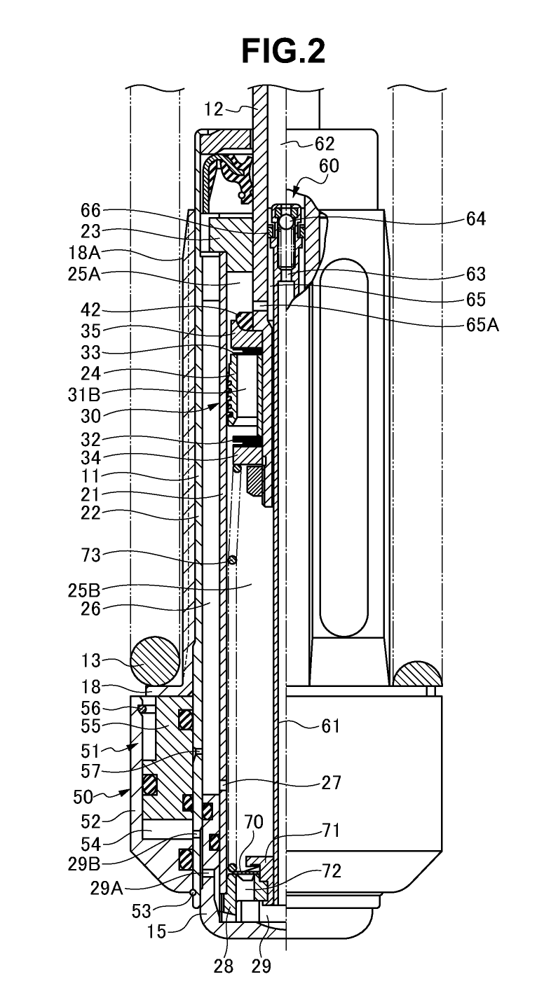

The piston valve apparatus 30 is structured, as shown in FIG. 2, such that an extension side oil path 31A (not shown) and a compression side oil path 31B which communicate the oil chamber 25A with the oil chamber 25B are pierced in the piston 24, an extension side disc valve 32 is provided in the extension side oil path 31A, and a compression side disc valve 33 is provided in the compression side oil path 31B. In an extension process, an extension side damping force is generated by flexibly deforming and pushing open the extension side disc valve 32 by a hydraulic pressure of the oil chamber 25A, and in a compression process, a compression side damping force is generated by flexibly deforming and pushing open the compression side disc valve 33 by a hydraulic pressure of the oil chamber 25B. A valve stopper 34 is provided for the extension side disc valve 32, and a valve stopper 35 is provided for the compression side disc valve 33.

In this case, the hydraulic shock absorber 10 is provided with a compression side shock absorbing rubber 41 which buffers the shock force at a time of a maximum compression and regulates a maximum compression stroke, and is provided with an extension side shock absorbing rubber 42 which buffers the shock force at a time of a maximum extension and regulates a maximum extension stroke.

Accordingly, the hydraulic shock absorber 10 has a vehicle height adjusting apparatus 50 which controls a vehicle height of the vehicle to be always at a fixed value regardless of a spring load on the suspension spring 13, as described below.

The vehicle height adjusting apparatus 50 is provided with a hydraulic jack 51 in an outer periphery of the outer tube 22 in the damper tube 11, as shown in FIGS. 1, 2 and 4. The hydraulic jack 51 is structured such that a jack housing 52 is inserted and attached in a liquid tight manner to an outer periphery of the outer tube 22 via an O-ring, a lower end of the jack housing 52 is supported by a stopper ring 53 locked and attached to the outer periphery of the outer tube 22, and a plunger 55 is inserted into an annular jack chamber 54 which is defined by the jack housing 52 and the outer periphery of the outer tube 22. The plunger 55 is inserted and attached in a liquid tight manner to each of an inner periphery of the jack housing 52 and an outer periphery of the outer tube 22 via an O-ring, and the spring receiver 18 for the suspension spring 13 mentioned above is supported by an upper surface of the plunger 55. The plunger 55 can be protruded from the jack chamber 54 by the working fluid fed to the jack chamber 54, and a protruding end is regulated by a stopper ring 56 which is locked and attached to an inner periphery on an opening end side of the jack housing 52.

In this case, the hydraulic jack 51 is provided with an oil return passage 57 in a hole shape, for returning the working fluid of the jack chamber 54 to the oil reservoir chamber 26 within the outer tube 22 of the damper tube 11 when the plunger 55 reaches the protruding end mentioned above protruding from the jack chamber 54, in the outer tube 22.

The vehicle height adjusting apparatus 50 has a hydraulic pump 60 carrying out a pumping action by the extending and retracting motion of the piston rod 12 with respect to the damper tube 11 so as to feed and discharge the working fluid to and from the jack chamber 54 of the hydraulic jack 51, and a blow valve 70 releasing a jack pressure Pa of the jack chamber 54 which is pressurized by the plunger 55 of the hydraulic jack 51 exposed to the spring load on the suspension spring 13.

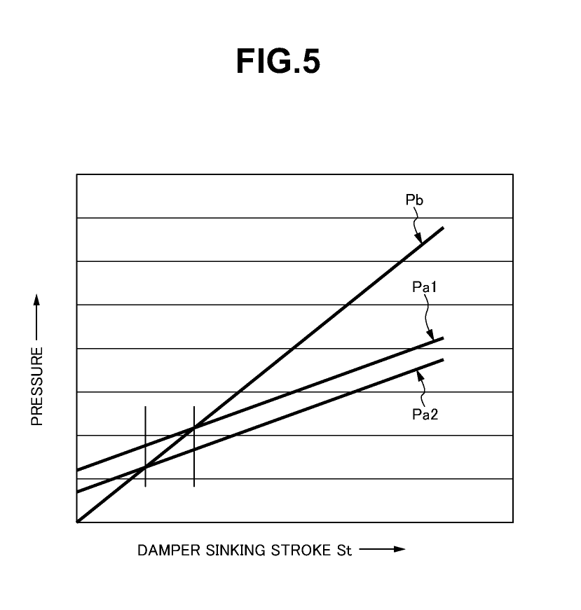

The vehicle height adjusting apparatus 50 is structured to control the vehicle to always have a fixed standard vehicle height, according to the vehicle height adjusting action in the following (1) and (2) (FIG. 5).

(1) In a range in which a damper sagging stroke St corresponding to an amount of displacement from an extending end of the piston rod 12 is small and the vehicle height is higher than the standard vehicle height, it is set such that the jack pressure Pa becomes smaller and a valve opening pressure Pb of the blow valve 70 becomes smaller than the jack pressure Pa as the vehicle height becomes higher. Accordingly, the vehicle height is brought down by opening the blow valve 70 to release the jack pressure Pa that the hydraulic pump 60 feeds to the hydraulic jack 51, and the vehicle height is brought down to the standard vehicle height.

(2) In a range in which the damper sagging stroke St is large and the vehicle height is lower than the standard vehicle height, it is set such that the jack pressure Pa becomes larger and the valve opening pressure Pb of the blow valve 70 becomes larger than the jack pressure Pa as the vehicle height becomes lower. Accordingly, the vehicle height is brought up by closing the blow valve 70 to stop the release of the jack pressure Pa which the hydraulic pump 60 feeds to the hydraulic jack 51, and the vehicle height is brought up to the standard vehicle height.

FIG. 5 shows the relationships (1) and (2) mentioned above which the jack pressure Pa (Pa1, Pa2) and the valve opening pressure Pb of the blow valve 70 have with respect to the damper sagging stroke St. Reference symbol Pa1 denotes a change of the jack pressure Pa in the case where a length (an initial length) of the suspension spring 13 is short when the damper sagging stroke St is zero. Reference symbol Pa2 denotes a change of the jack pressure Pa in the case where the length (the initial length) of the suspension spring 13 is long when the damper sagging stroke St is zero. Change rates (gradients) of the pressures Pa1 and Pa2 with respect to the damper sagging stroke St are the same. In this case, the standard vehicle height of the vehicle is a vehicle height which the vehicle height adjusting apparatus 50 applies to the vehicle when Pa=Pb.

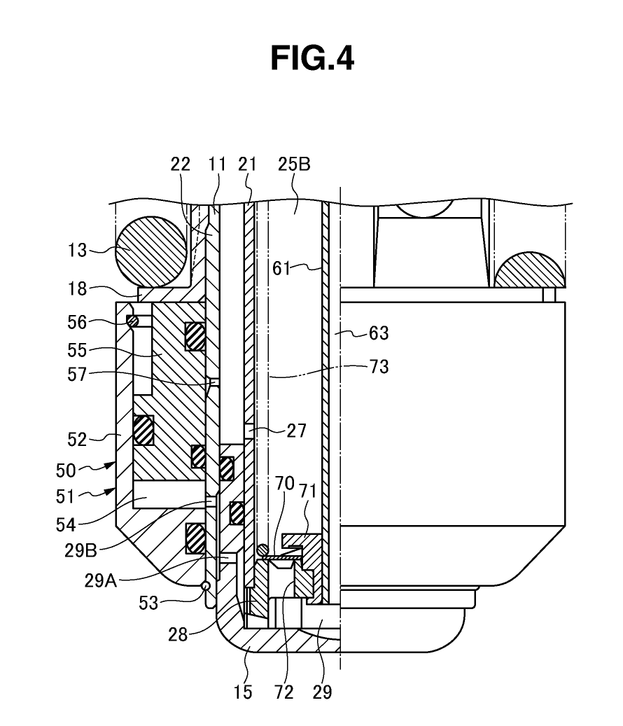

In the hydraulic shock absorber 10 according to the present embodiment, an end piece 28 partitioning the piston side oil chamber 25B in the inner tube 21 of the damper tube 11 and the jack chamber 54 of the hydraulic jack 51 is provided on an inner surface of the bottom cup 15 corresponding to a bottom portion of the damper tube 11, and the damper tube 11 has the hydraulic pump 60 and the blow valve 70 built-in, as shown in FIG. 4. The end piece 28 is pinched and fixed between an inner surface of the bottom cup 15 and a lower end of the inner tube 21, and forms a communication passage 29 with respect to the inner surface of the bottom cup 15, and the communication passage 29 is communicated with the jack chamber 54 via a communication hole 29A provided in the bottom cup 15 and a communication hole 29B provided in the outer tube 22.

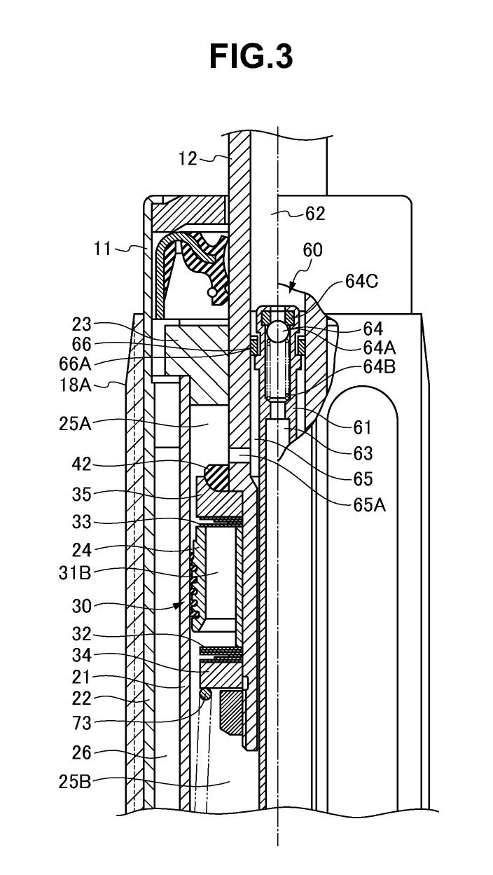

Further, the hydraulic pump 60 is constructed by slidably inserting a hollow pipe 61 provided upright by being fitted to a center hole of a valve stopper 71 for the blow valve 70 fixed to the center of the end piece 28 of the damper tube 11 to the pump chamber 62 formed by the hollow portion of the piston rod 12, as shown in FIGS. 3 and 4. A discharge passage 63 of the hydraulic pump 60, which will be described later, is communicated with the jack chamber 54 of the hydraulic jack 51 via the communication passage 29 and the communication holes 29A and 29B described above.

Further, the hydraulic pump 60 is provided with a discharge check valve 64 in a discharge passage 63 discharging the working fluid in the pump chamber 62, pressurized by a retracting action that the piston rod 12 moves into the damper tube 11 and the hollow pipe 61, to the side of the hydraulic jack 51, and is provided with a sucking check valve 66 in a suction passage 65 sucking the working fluid in the inner tube 21 of the damper tube 11 to the pump chamber 62 which becomes a negative pressure as a result of an extending action that the piston rod 12 moves out of the damper tube 11 and the hollow rod 61. The discharge passage 63 is constructed as a hollow portion of the hollow pipe 61. The discharge check valve 64 presses a ball valve 64A mounted in the hollow portion of the hollow pipe 61 by a coil spring 64B against a valve seat 64C which is fixed by clinching to the open end of the hollow pipe 61, moves the ball valve 64A away from the valve seat 64C by the pressurization of the pump chamber 62 so as to open, and makes the ball valve 64A seat on the valve seat 64C so as to close at when the pressure of the pump chamber 62 is negative. The suction passage 65 is formed by a suction hole 65A which passes through inside and outside the piston rod 12 so as to be open to the piston rod side oil chamber 25A, and an annular gap between the inner periphery of the piston rod 12 and the outer periphery of the hollow pipe 61. The suction check valve 66 is mounted on the outer periphery of the hollow pipe 61 so as to be slidable up and down, is constructed by a piston ring 66A which is provided with a notch groove in an upper end surface, moves down the piston ring 66A by the pressurization of the pump chamber 62 so as to close the suction passage 65, and moves up the piston ring 66A so as to open the suction passage 65 when the pressure of the pump chamber 62 is negative.

Accordingly, the hydraulic pump 60 carries out the pumping action by the retracting motion of the piston rod 12 moving into and out of the damper tube 11 and the hollow pipe 61, generated when the vehicle travels and the hydraulic shock absorber 10 is excited by an irregularity of the road surface. When the pump chamber 62 is pressurized by the pumping action due to the compressing motion of the piston rod 12, the oil in the pump chamber 62 opens the discharge check valve 64 so as to be discharged to the side of the hydraulic jack 51 through the discharge passage 63 in the hollow portion of the hollow pipe 61. If the pressure of the pump chamber 62 becomes negative as a result of the pumping action due to the extending motion of the piston rod 12, the oil in the piston rod side oil chamber 25A of the damper tube 11 opens the suction check valve 66 so as to be sucked into the pump chamber 62 through the suction passage 65 in the outer periphery of the hollow pipe 61.

Further, the vehicle height adjusting apparatus 50 is provided with a blow passage 72 leading the discharge passage 63, the communication passage 29 and the communication holes 29A and 29B between the pump chamber 62 of the hydraulic pump 60 and the jack chamber 54 of the hydraulic jack 51 to the piston side oil chamber 25B in the inner tube 21 of the damper tube 11, in the end piece 28 of the damper tube 11, as shown in FIGS. 3 and 4. The blow valve 70 is formed as a disc shape, is loosely inserted to an outer periphery of a valve stopper 71 provided in the end piece 28, is seated on a seat surface facing to the piston side oil chamber 25B of the end piece 28 by a disc spring, and opens and closes the blow passage 72. The blow valve 70 is biased in a closing direction by biasing means 73 constructed by a coil spring that is interposed between the blow valve 70 and the valve stopper 34 of the extension side disc valve 32 provided in the piston rod 12. The valve opening pressure Pb mentioned above of the blow valve 70 is determined depending on the biasing means 73, and varies as shown in FIG. 5 as a spring length of the biasing means 73 is changed in response to the damper sagging stroke St mentioned above due to the extension and retraction of the hydraulic shock absorber 10.

According to the present embodiment, the following operations and effects can be achieved.

(a) In a range in which the spring load on the suspension spring 13 is reduced by unloading goods from a vehicle in the standard vehicle height state, for example, the damper (the hydraulic shock absorber 10) is extended, the damper sagging stroke St corresponding to the amount of displacement from the extending end of the piston rod 12 becomes small, and the vehicle height becomes higher than the standard vehicle height, it is set such that the jack pressure Pa becomes smaller and the valve opening pressure Pb of the blow valve 70 becomes smaller than the jack pressure Pa as the vehicle height becomes higher. At this time, if the hydraulic shock absorber 10 is excited by the irregularity of the road surface while the vehicle travels, and the hydraulic pump 60 carries out the pumping action, the jack pressure Pa which the hydraulic pump 60 feeds to the hydraulic jack 51 is released to the side of the piston side oil chamber 25B by opening the blow valve 70, and the vehicle height is brought down to the standard vehicle height.

(b) In a range in which the spring load on the suspension spring 13 is increased by loading goods to a vehicle in the standard vehicle height state, for example, the damper sags, the damper sagging stroke St becomes large, and the vehicle height becomes lower than the standard vehicle height, it is set such that the jack pressure Pa becomes larger and the valve opening pressure Pb of the blow valve 70 becomes larger than the jack pressure Pa as the vehicle height becomes lower. At this time, if the hydraulic shock absorber 10 is excited by the irregularity of the road surface while the vehicle travels, and the hydraulic pump 60 carries out the pumping action, the release of the jack pressure Pa which the hydraulic pump 60 feeds to the hydraulic jack 51 to the side of the piston side oil chamber 25B is stopped by closing the blow valve 70, and the vehicle height is brought up to the standard vehicle height.

(c) According to the vehicle height adjusting apparatus 50 having the simple and compact structure in which the jack pressure Pa of the hydraulic jack 51 and the valve opening pressure Pb of the blow valve 70 are set so as to satisfy the relationships (a) and (b) mentioned above with respect to the damper sagging stroke St, the vehicle height can be controlled to be always at a fixed value regardless of the spring load on the suspension spring 13.

(d) The hydraulic shock absorber 10 described in the above (a) to (c) has the blow valve 70 releasing the jack pressure Pa in the jack chamber 54 which is pressurized by the plunger 55 of the hydraulic jack 51 exposed to the spring load on the suspension spring 13. In this case, the blow valve 70 is provided in the end piece 28 of the damper tube 11 in such a manner as to open and close the blow passage 72 formed in the end piece 28 and leads the discharge passage 63 between the pump chamber 62 and the jack chamber 54 to the oil chamber 25B in the damper tube 11, and is biased in the closing direction by the biasing means 73 interposed between the blow valve 70 and the piston rod 12. Accordingly, it is possible to control the vehicle height to be always at a fixed value regardless of the spring load on the suspension spring 13, according to the simple and compact structure in which the spring characteristic of the suspension spring 13 pushing down the plunger 55 of the hydraulic jack 51 and the spring characteristic of the biasing means 73 biasing the blow valve 70 in the closing direction are set in such a manner that the jack pressure Pa of the hydraulic jack 51 and the valve opening pressure Pb of the blow valve 70 satisfy the relationships (a) and (b) mentioned above with respect to the damper sagging stroke.

(e) There is provided in the damper tube 11 the oil return passage 57 returning the working fluid in the jack chamber 54 into the damper tube 11 when the plunger 55 reaches the protruding end at which the plunger 55 protrudes from the jack chamber 54 due to the working fluid fed to the jack chamber 54 of the hydraulic jack 51. Accordingly, it is possible to avoid an unnecessary rise of the jack pressure Pa of the hydraulic jack 51, and it is possible to protect a sealing function of the hydraulic system.

### Embodiment 2

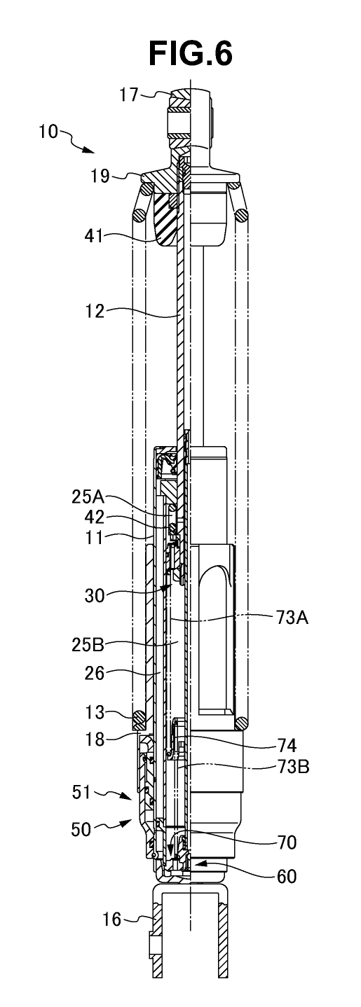

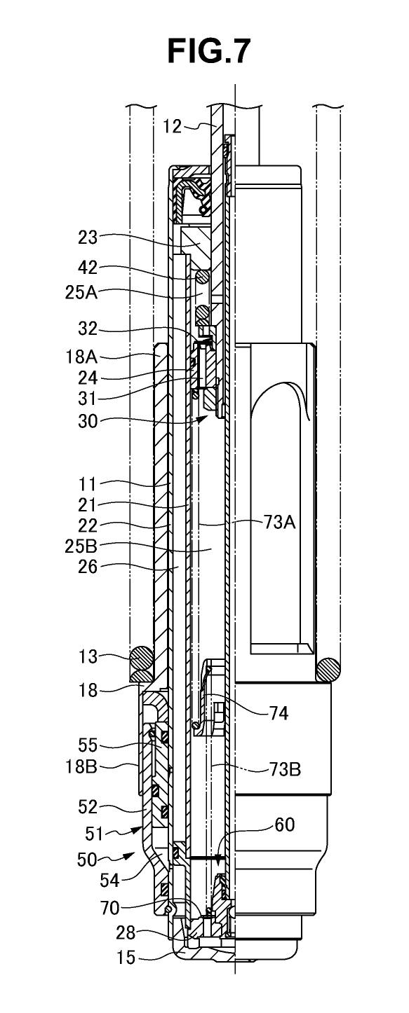

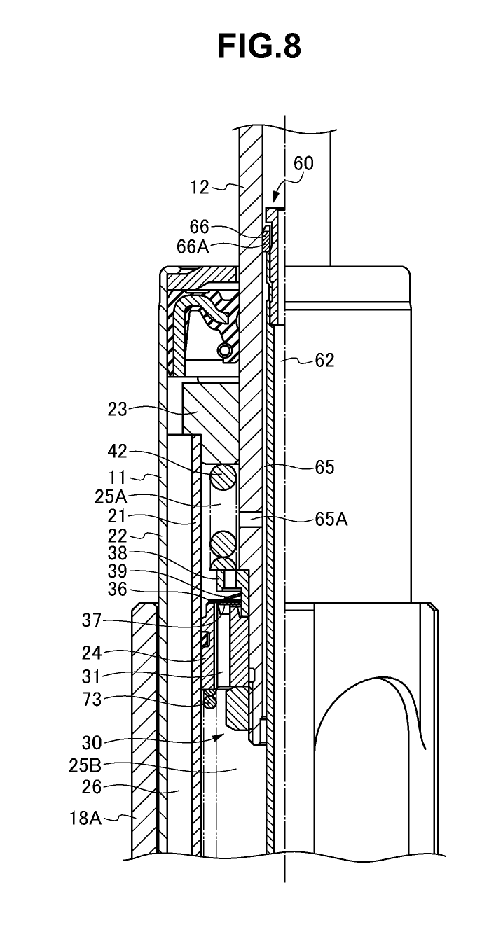

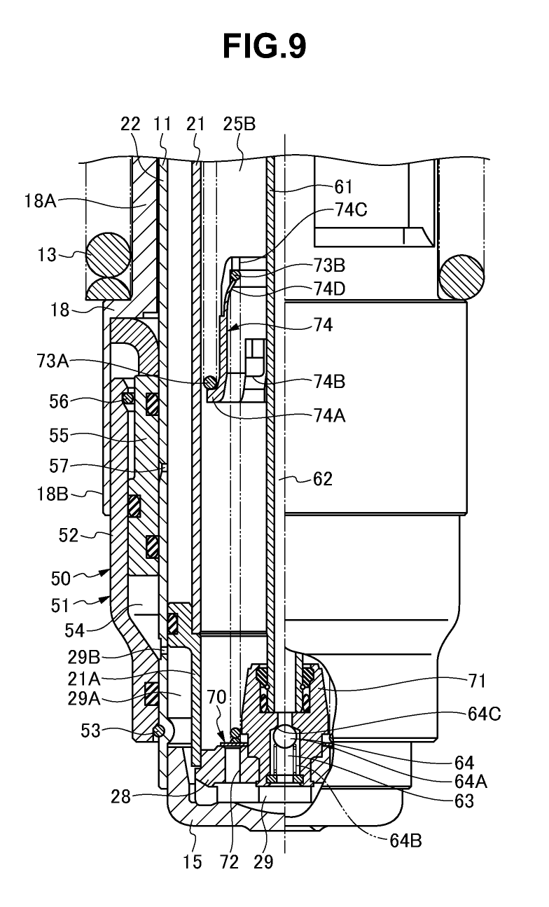

### FIGS. 6 to 10B

FIGS. 6 to 10B show a hydraulic shock absorber 10 according to an embodiment 2, in which members that are substantially the same as those of the embodiment 1 are assigned with the same reference numerals. Substantial difference of the hydraulic shock absorber 10 according to the embodiment 2 from the hydraulic shock absorber 10 according to the embodiment 1 lies in the structures of the pump chamber 62, the discharge passage 63 and the discharge check valve 64 of the hydraulic pump 60, and the structure of the biasing means 73 of the blow valve 70.

In the hydraulic pump 60, the hollow pipe 61 is provided upright on the valve stopper 71 of the blow valve 70 fixed to the end piece 28, the pump chamber 62 is formed by the hollow portion of the piston rod 12 and the hollow portion of the hollow pipe 61, the discharge passage 63 is formed in the valve stopper 71, and the discharge check valve 64 is provided in the discharge passage 63. The discharge check valve 64 is structured so as to press the ball valve 64A mounted into the discharge passage 63 of the valve stopper 71 by the coil spring 64B against the valve seat 64C formed in the valve stopper 71, move the ball valve 64A away from the valve seat 64C by the pressurization of the pump chamber 62 so as to open, and make the ball valve 64A seat on the valve seat 64C so as to close when the pressure of the pump chamber 62 is negative. In this case, a partition wall collar 21A provided in the lower end portion of the inner tube 21 pinches and retains the end piece 28 with the inner surface of the bottom cup 15, and a communication passage 29A communicating the communication passage 29 to which the discharge passage 63 of the hydraulic pump 60 is open with the side of the jack chamber 54 of the hydraulic jack 51 is defined by the partition wall collar 21A, the bottom cup 15 and the outer tube 22.

The biasing means 73 is divided into an upper coil spring 73A having a large coil diameter and a lower coil spring 73B having a small coil diameter, a lower end of the upper coil spring 73A is attached to an outer peripheral portion of a spring joint 74, an upper end of the lower coil spring 73B is attached to an inner peripheral portion of the spring joint 74, an upper end of the upper coil spring 73A is supported on a surface facing to the piston side oil chamber 25B of the piston 24 provided in the piston rod 12, and a lower end of the lower coil spring 73B is supported on the blow valve 70. As a result, the blow valve 70 is biased in a closing direction by a combined spring force of the upper coil spring 73A and the lower coil spring 73B. Since the lower end of the upper coil spring 73A and the upper end of the lower coil spring 73B are attached to the inner and outer peripheries of the spring joint 74, it is possible to overlap the lower end and the upper end for a length which is approximately a length of the spring joint 74 in an axial direction so as to make a storage length of the upper coil spring 73A and the lower coil spring 73B within a range of a distance length between the piston 24 of the piston rod 12 and the blow valve 70 at the overlapping amount, which improves the spring characteristics of the coil springs 73A and 73B biasing the blow valve 70.

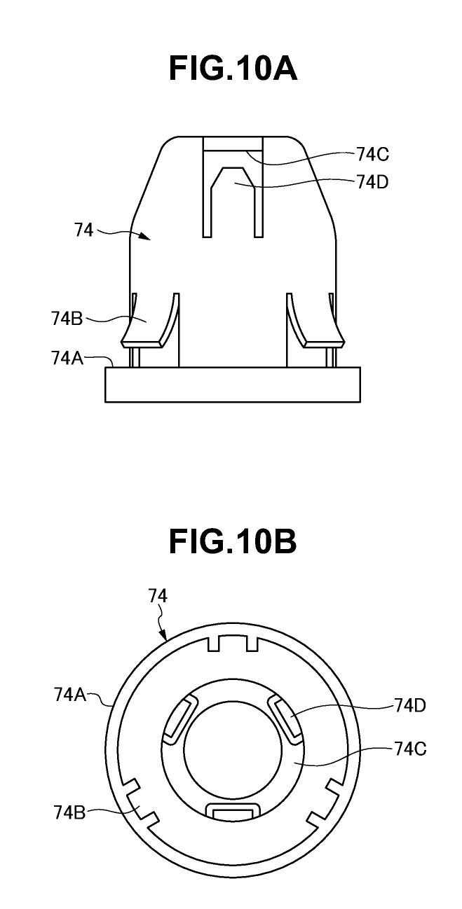

The spring joint 74 is provided with an outward protruding claw portion 74B and an inward protruding claw portion 74D between an outer peripheral protruding portion 74A in a lower end and an inner peripheral protruding portion 74C in an upper end, as shown in FIGS. 10A and 10B. A lower end of the upper coil spring 73A attached to an outer periphery of the spring joint 74, by elastically deforming the outward protruding claw portion 74B in such a manner as to temporarily contract, and an element wire in its terminal is pinched and held between the outer peripheral protruding portion 74A and the outward protruding claw portion 74B. An upper end of the lower coil spring 73B is attached to an inner periphery of the spring joint 74, by elastically deforming the inward protruding claw portion 74D in such a manner as to temporarily expand, and an element wire in its terminal is pinched and held between the inner peripheral protruding portion 74C and the inward protruding claw portion 74D.

In this case, in the hydraulic shock absorber 10 according to the embodiment 2, the spring receiver 18 includes a spring guide 18A, and further includes a dust seal 18B extending to coat the outer periphery of the jack housing 52 and the plunger 55.

Further, in the hydraulic shock absorber 10 according to the embodiment 2, the piston valve apparatus 30 is provided with an oil path 31 communicating the piston rod side oil chamber 25A and the piston side oil chamber 25B in the piston 24, and is also provided with a perforated valve 36 opening and closing an opening of the oil path 31 to the oil chamber 25A, and a disc valve 37 attached to the perforated valve 36 in such a manner as to close a hole of the perforated valve 36 from the side of the oil path 31. In an extension process, an extension side damping force is generated by flexibly deforming and pushing open the disc valve 37 by the hydraulic pressure of the oil chamber 25A passing through the hole of the perforated valve 36, and in a compression process, a compression side damping force is generated by sliding to push open the perforated valve 36 and the disc valve 37 by the hydraulic pressure of the oil chamber 25B. A valve stopper 38 is provided for the perforated valve 36, along with a valve spring 39.

Further, in the hydraulic shock absorber 10 according to the embodiment 2, an extension side shock absorbing spring 42 is substituted for the extension side shock absorbing rubber 42 according to the embodiment 1.

### Embodiment 3

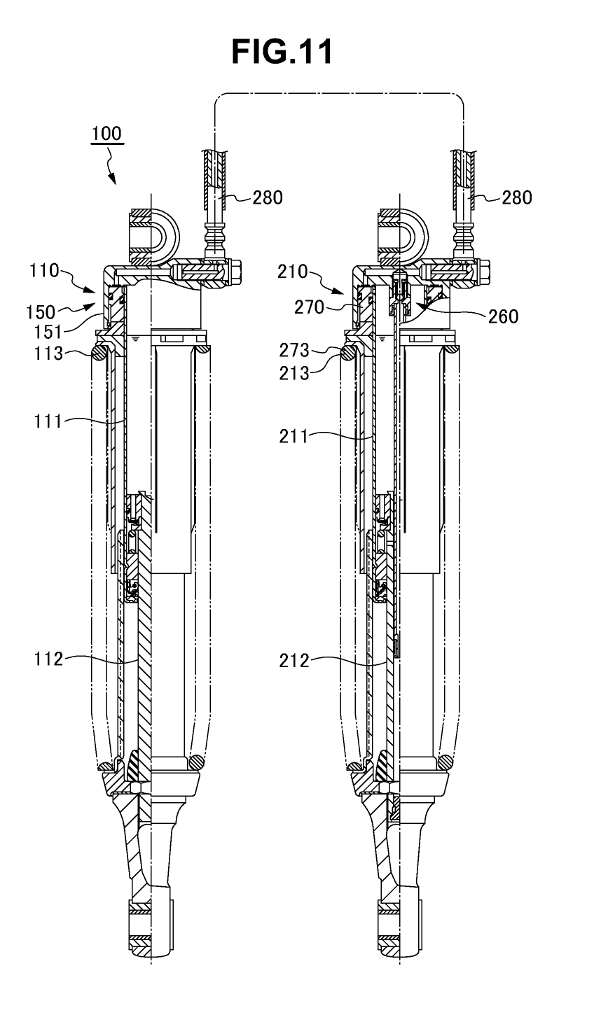

### FIGS. 11 to 18

A hydraulic shock absorber 100 shown in FIG. 11 is structured such that first and second hydraulic shock absorbers 110 and 210 are arranged in line. The first and second hydraulic shock absorbers 110 and 210 constitute, for example, a rear wheel suspension apparatus that is interposed between a rear axle side and a vehicle body side, on each of right and left sides of a motor cycle.

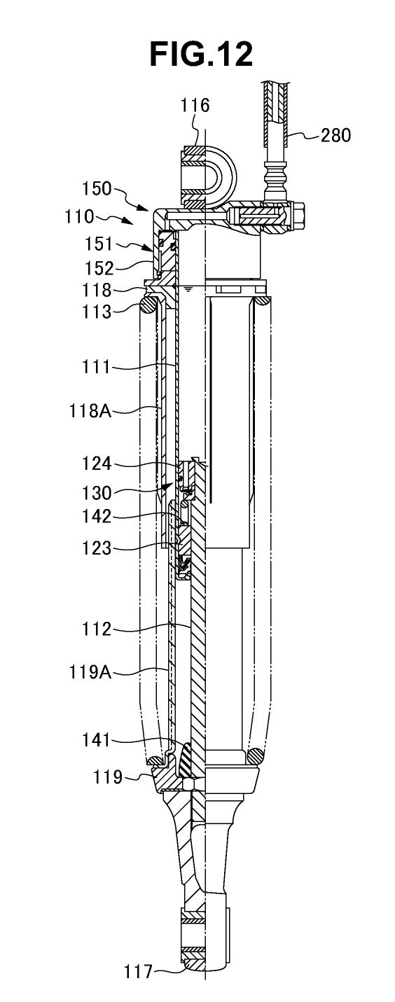

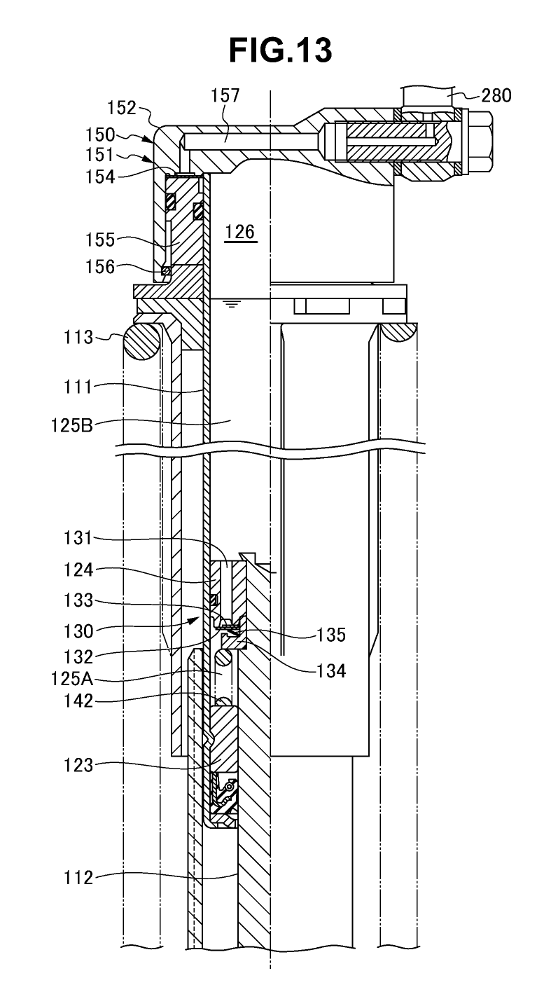

The first hydraulic shock absorber 110 has a damper tube 111 which is attached to the vehicle body side, a piston rod 112 which is attached to the axle side and slides within the damper tube 111 via a piston 124 so as to extend and retract with respect to the damper tube 111, and a suspension spring 113 which is arranged along an outer periphery of the damper tube 111 and the piston rod 112, as shown in FIGS. 12 and 13.

A jack housing 152 of a hydraulic jack 151 of a vehicle height adjusting apparatus 150, which will be described later, is attached to an upper end portion of the damper tube 111, and a vehicle body side attaching member 116 is fixed to the jack housing 152. An axle side attaching member 117 is fixed to a lower end portion of the piston rod 112.

An outer periphery of an upper end portion of the damper tube 111 is equipped with a spring receiver 118 which is supported by a plunger 155 inserted to a jack chamber 154 of the hydraulic jack 151 of the vehicle height adjusting apparatus 150, the piston rod 112 is equipped with a spring receiver 119 which is supported by the axle side attaching member 117, an upper end of the suspension spring 113 is supported by the spring receiver 118, and a lower end of the suspension spring 113 is supported by the spring receiver 119. The spring receiver 118 is provided with a spring guide 118A, and the spring receiver 119 is provided with a spring guide 119A.

In the first hydraulic shock absorber 110, the piston rod 112 penetrates and is supported by a rod guide 123 fixed to an opening end of the damper tube 111, and a piston 124 is fixed to an inserting end of the piston rod 112 to the damper tube 111. The first hydraulic shock absorber 110 is structured such that a piston rod side oil chamber 125A and a piston side oil chamber 125B which are separated by the piston 124 are formed inside the damper tube 111, the working fluid is charged in the oil chambers 125A and 125B, and an upper space of the piston side oil chamber 125B inside the damper tube 111 is formed as an air chamber 126. The air chamber 126 is extended and retracted by the piston rod 112 which moves into and out of the damper tube 111 with the extension and retraction of the hydraulic shock absorber 110 so as to compensate for the working fluid of an amount corresponding to a volumetric capacity of a forward and backward movement of the piston rod 112.

The first hydraulic shock absorber 110 is provided with a piston valve apparatus 130 in the piston 124, which allows the piston rod side oil chamber 125A and the piston side oil chamber 125B to be communicated and constitutes a damping force generating apparatus. The first hydraulic shock absorber 110 attenuates an extending and retracting oscillation of the damper tube 111 and the piston rod 112 caused by an absorption of a shock force from a road surface by the suspension spring 113, by means of the damping force generating apparatus constituted by the piston valve apparatus 130.

The piston valve apparatus 130 is structured, as shown in FIG. 13, such that an oil path 131 which communicates the oil chamber 125A and the oil chamber 125B is pierced in the piston 124, and is provided with a perforated valve 132 opening and closing an opening of the oil path 131 to the oil chamber 125A, and a disc valve 133 attached to the perforated valve 132 in such a manner as to close a hole of the perforated valve 132 from a side of the oil path 131. In an extension process, an extension side damping force is generated by flexibly deforming and pushing open the disc valve 133 by a hydraulic pressure of the oil chamber 125A passing through the hole of the perforated valve 132, and in a compression process, a compression side damping force is generated by sliding and pushing open the perforated valve 132 and the disc valve 133 by the hydraulic pressure of the oil chamber 125B. A valve stopper 134 is provided for the perforated valve 132, along with a valve spring 135.

In this case, the first hydraulic shock absorber 110 is provided with a compression side shock absorbing rubber 141 which buffers the shock force at a time of a maximum compression and regulates a maximum compression stroke, and is provided with an extension side shock absorbing rubber 142 which buffers the shock force at a time of a maximum extension, and regulates a maximum extension stroke.

Accordingly, the hydraulic shock absorber 110 has a vehicle height adjusting apparatus 150 which controls a vehicle height of the vehicle to be always at a fixed value regardless of a spring load on the suspension spring 113, as described below.

The vehicle height adjusting apparatus 150 is provided with a hydraulic jack 151 in an outer periphery of the damper tube 111, as shown in FIG. 13. The hydraulic jack 151 is structured such that a jack housing 152 is attached in a liquid tight manner to an outer periphery of the damper tube 111, and a plunger 155 is inserted to an annular jack chamber 154 defined by the jack housing 152 and the outer periphery of the damper tube 111. The plunger 155 is inserted and attached in a liquid tight manner to each of an inner periphery of the jack housing 152 and an outer periphery of the damper tube 111 via an O-ring, and the spring receiver 118 for the suspension spring 113 mentioned above is supported by a lower surface of the plunger 155. The plunger 155 can be protruded from the jack chamber 154 by the working fluid fed to the jack chamber 154, and a protruding end thereof is regulated by a stopper ring 156 which is locked and attached to an inner periphery on an opening end side of the jack housing 152.

In the vehicle height adjusting apparatus 150, the working fluid, that a hydraulic pump 260 provided in a second hydraulic shock absorber 210 pressure feeds in a manner described below, is fed to and discharged from the jack chamber 154 of the hydraulic jack 151.

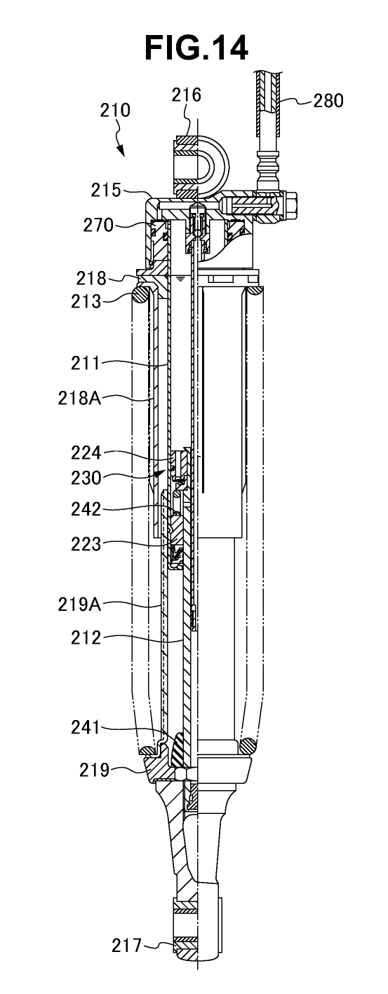

The second hydraulic shock absorber 210 has a damper tube 211 which is attached to the vehicle body side, a piston rod 212 which is attached to the axle side and slides via the piston 224 within the damper tube 211 so as to extend and retract with respect to the damper tube 211, and a biasing spring 213 which is arranged along an outer periphery of the damper tube 211 and the piston rod 212, as shown in FIGS. 14 to 17.

An end housing 215 in which a hydraulic pump 260 and a blow valve 270 are built-in, which will be described later, is attached to an upper end portion of the damper tube 211, and a vehicle body side attaching member 216 is fixed to the end housing 215. An axle side attaching member 217 is fixed to a lower end portion of the piston rod 212.

An outer periphery of an upper end portion of the damper tube 211 is equipped with a spring receiver 218 which is supported by the blow valve 270 built-in in the end housing 215, the piston rod 212 is equipped with the spring receiver 219 which is supported by the axle side attaching member 217, an upper end of the biasing spring 213 is supported by the spring receiver 218, and a lower end of the biasing spring 213 is supported by a spring receiver 219. The spring receiver 218 is provided with a spring guide 218A, and the spring receiver 219 is provided with a spring guide 219A.

The second hydraulic shock absorber 210 supports the penetrating piston rod 212 on a rod guide 223 that is fixed to an opening end of the damper tube 211, and is provided with a piston 224 fixed to an insertion end of the piston rod 212 to the damper tube 211. The second hydraulic shock absorber 210 is structured such that a piston rod side oil chamber 225A and a piston side oil chamber 225B which are separated by the piston 224 are formed inside the damper tube 211, the working fluid is charged in the oil chambers 225A and 225B, and an upper space of the piston side oil chamber 225B inside the damper tube 211 is formed as an air chamber 226. The air chamber 226 is extended and retracted by the piston rod 212 which is moved into and out of the damper tube 211 with the extension and retraction of the second hydraulic shock absorber 210, and compensates for the working fluid of an amount corresponding to a volumetric capacity of the forward and backward movement of the piston rod 212.

The hydraulic shock absorber 210 is provided with a piston valve apparatus 230 in the piston 224, which allows the piston rod side oil chamber 225A and the piston side oil chamber 225B to be communicated and constitutes a damping force generating apparatus. The hydraulic shock absorber 210 attenuates an extending and retracting oscillation of the damper tube 211 and the piston rod 212 caused by an absorption of a shock force from a road surface by the biasing spring 213, by means of the damping force generating apparatus constituted by the piston valve apparatus 230.

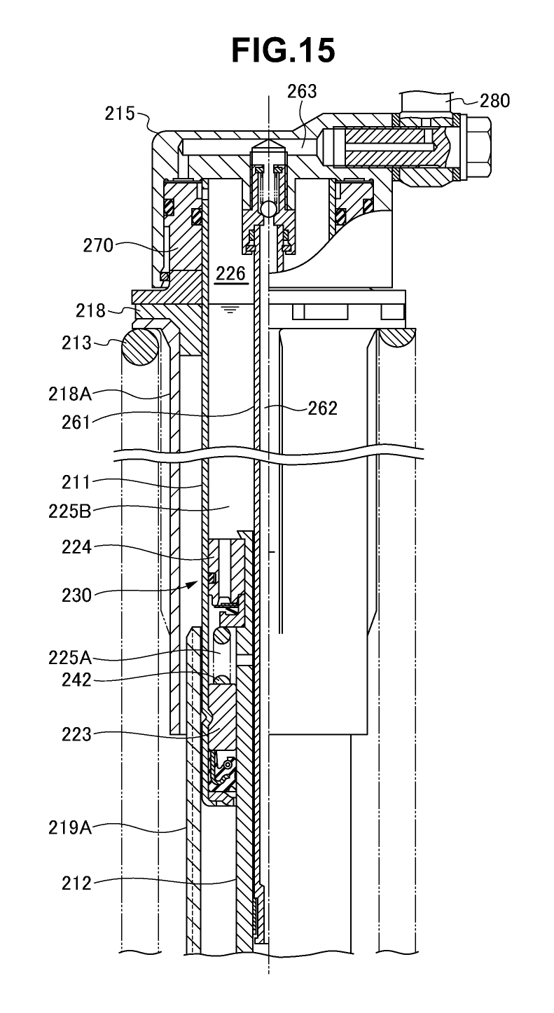

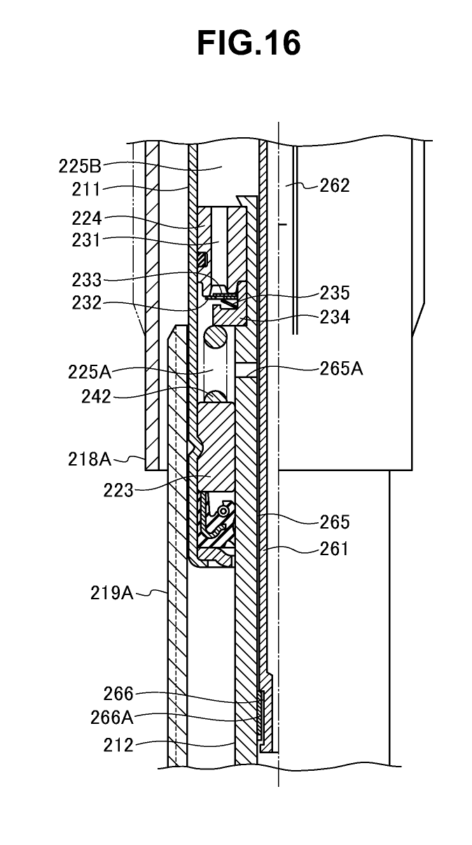

The piston valve apparatus 230 is structured, as shown in FIGS. 15 and 16, such that an oil path 231 which communicates the oil chamber 225A and the oil chamber 225B is pierced in the piston 224, and is provided with a perforated valve 232 opening and closing an opening of the oil path 231 to the piston rod side oil chamber 225A, and a disc valve 233 which is attached to the perforated valve 232 for closing a hole in the perforated valve 232 from a side of the oil path 231. In an extension process, an extension side damping force is generated by flexibly deforming and pushing open the disc valve 233 by a hydraulic pressure of the oil chamber 225A passing through the hole of the perforated valve 232, and in a compression process, a compression side damping force is generated by sliding and pushing open the perforated valve 232 and the disc valve 233 by a hydraulic pressure of the oil chamber 225B. A valve stopper 234 is provided for the perforated valve 232, along with a valve spring 235.

In this case, the second hydraulic shock absorber 210 is provided with a compression side shock absorbing rubber 241 which buffers the shock force at a time of a maximum compression and regulates a maximum compression stroke, and is provided with an extension side shock absorbing spring 242 which buffers the shock force at a time of a maximum extension and regulates a maximum extension stroke.

Accordingly, the second hydraulic shock absorber 210 has a hydraulic pump 260 which feeds and discharges the working fluid to and from the jack chamber 154 of the hydraulic jack 151 of the first hydraulic shock absorber 110 by carrying out a pumping action by the extending and retracting motion of the piston rod 212 with respect to the damper tube 211, and a blow valve 270 which releases a jack pressure Pa of the jack chamber 154 pressurized by the plunger 155 of the hydraulic jack 151 exposed to the spring load on the suspension spring 113 of the first hydraulic shock absorber 110.

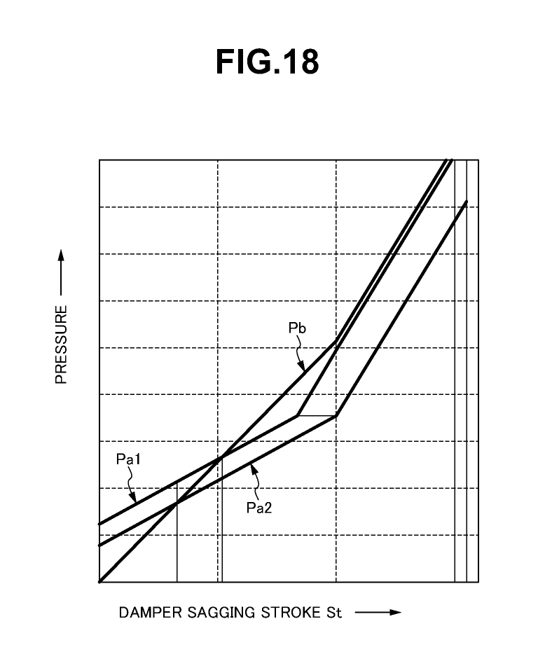

The vehicle height adjusting apparatus 150 is constructed by the hydraulic jack 151 of the first hydraulic shock absorber 110, the hydraulic pump 260 and the blow valve 270 of the second hydraulic shock absorber 210, and is structured so as to control the vehicle to always have a fixed standard vehicle height, according to the vehicle height adjusting action in the following (1) and (2) (FIG. 18).

(1) In a range in which the damper sagging stroke St corresponding to an amount of displacement from an extending end of the piston rod 112 of the first hydraulic shock absorber 110 is small and the vehicle height is higher than the standard vehicle height, it is set such that the jack pressure Pa of the first hydraulic shock absorber 110 becomes smaller and the valve opening pressure Pb of the blow valve 270 of the second hydraulic shock absorber 210 becomes smaller than the jack pressure Pa as the vehicle height becomes higher. Accordingly, the vehicle height is brought down by opening the blow valve 270 to release the jack pressure Pa which the hydraulic pump 260 of the second hydraulic shock absorber 210 feeds to the hydraulic jack 151 of the first hydraulic shock absorber 110, and the vehicle height is brought down to the standard vehicle height.

(2) In a range in which the damper sagging stroke St of the first hydraulic shock absorber 110 is large and the vehicle height is lower than the standard vehicle height, it is set such that the jack pressure Pa of the first hydraulic shock absorber 110 becomes larger and the valve opening pressure Pb of the blow valve 270 of the second hydraulic shock absorber 210 becomes larger than the jack pressure Pa as the vehicle height becomes lower. Accordingly, the vehicle height is brought up by closing the blow valve 270 to stop the release of the jack pressure Pa which the hydraulic pump 260 of the second shock absorber 210 feeds to the hydraulic jack 151 of the first hydraulic shock absorber 110, and the vehicle height is brought up to the standard vehicle height.

FIG. 18 shows the relationships (1) and (2) mentioned above which the jack pressure Pa (Pa1, Pa2) and the valve opening pressure Pb of the blow valve 270 have with respect to the damper sagging stroke St. Reference symbol Pa1 denotes a change of the jack pressure Pa in the case where a length (an initial length) of the suspension spring 113 is short when the damper sagging stroke St is zero. Reference symbol Pa2 denotes a change of the jack pressure Pa in the case where the length (the initial length) of the suspension spring 113 is long when the damper sagging stroke St is zero. Change rates (gradients) of the pressures Pa1 and Pa2 with respect to the damper sagging stroke St are the same. In this case, the standard vehicle height of the vehicle is a vehicle height which the vehicle height adjusting apparatus 150 applies to the vehicle when Pa=Pb.

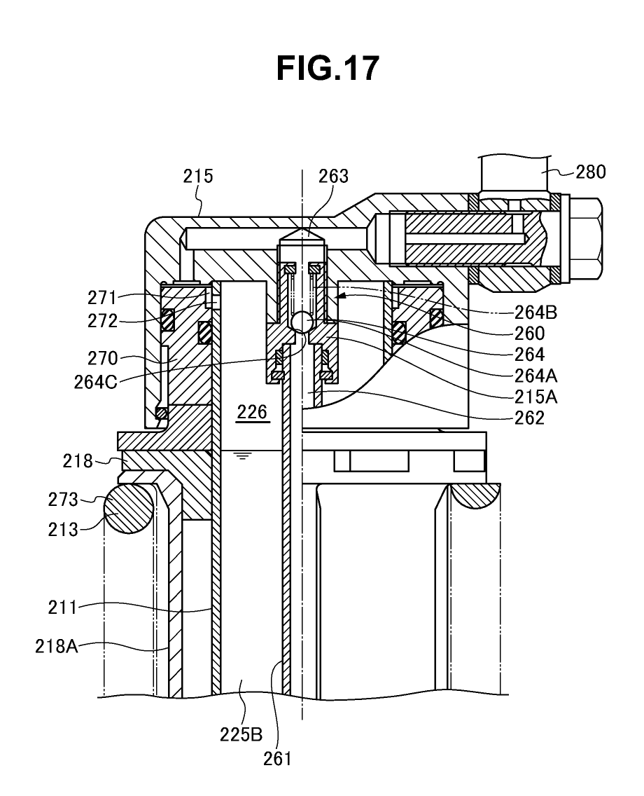

In the second hydraulic shock absorber 210 according to the present embodiment, an end housing 215 is attached in a liquid tight manner to an upper end portion of the damper tube 211, and the end housing 215 has the hydraulic pump 260 and the blow valve 270 built-in, as shown in FIGS. 15 and 17.

Further, the hydraulic pump 260 is constructed by slidably inserting a hollow pipe 261, provided upright by being fitted to a center hole of a valve housing 215A for a discharge check valve 264 of the hydraulic pump 260 fixed by screwing to the center of the end housing 215 of the damper tube 211, to the pump chamber 262 formed by the hollow portion of the piston rod 212, as shown in FIG. 17. A discharge passage 263 of the hydraulic pump 260, which will be described later, is communicated with the jack chamber 154 of the hydraulic jack 151 via a working fluid feeding and discharging pipe 280 extended between the first hydraulic shock absorber 110 and the second hydraulic shock absorber 210, and the communication passage 157 provided in the jack housing 152 of the first hydraulic shock absorber 110.

Further, the hydraulic pump 260 is provided with a discharge passage 263 discharging the working fluid of the pump chamber 262, pressurized by a retracting action that the piston rod 212 moves into the damper tube 211 and the hollow pipe 261, to the side of the hydraulic jack 151 in the end housing 215 and the valve housing 215A, is provided with a discharge check valve 264 in the discharge passage 263 provided in the valve housing 215A, and is provided with a suction check valve 266 in a suction passage 265 sucking the working fluid in the damper tube 211 to the pump chamber 262 which becomes a negative pressure as a result of an extending action that the piston rod 212 moves out of the damper tube 211 and the hollow rod 261. The discharge check valve 264 presses a ball valve 264A mounted in the discharge passage 263 of the valve housing 215A by a coil spring 264B against a valve seat 264C provided in the valve housing 215A, moves the ball valve 264A away from the valve seat 264C by the pressurization of the pump chamber 262 so as to open, and makes the ball valve 264A seat on the valve seat 264C so as to close when the pressure of the pump chamber 262 is negative. The suction passage 265 is formed by a suction hole 265A which passes through inside and outside the piston rod 212 so as to be open to the piston rod side oil chamber 225A, and an annular gap between the inner periphery of the piston rod 212 and the outer periphery of the hollow pipe 261. The suction check valve 266 is mounted on the outer periphery of the hollow pipe 261 so as to be slidable up and down, is constructed by a piston ring 266A which is provided with a notch groove in a lower end surface, moves up the piston ring 266A by the pressurization of the pump chamber 262 so as to close the suction passage 265, and moves down the piston ring 266A so as to open the suction passage 265 when the pressure of the pump chamber 262 is negative.

Accordingly, the hydraulic pump 260 carries out the pumping action by the retracting motion of the piston rod 212 moving into and out of the damper tube 211 and the hollow pipe 261, generate when the vehicle travels and the hydraulic shock absorber 210 is excited by an irregularity of the road surface. When the pump chamber 262 is pressurized by the pumping action due to the compressing motion of the piston rod 212, the oil in the pump chamber 262 opens the discharge check valve 264 so as to be discharged to the side of the hydraulic jack 151 of the first hydraulic shock absorber 110 through the discharge passage 263 of the end housing 215 via the working fluid feeding and discharging pipe 280, and the communication passage 157 of the jack housing 152 of the first hydraulic shock absorber 110. If the pressure of the pump chamber 262 becomes negative as a result of the pumping action due to the extending motion of the piston rod 212, the oil in the piston rod side oil chamber 225A of the damper tube 211 opens the suction check valve 266 so as to be sucked into the pump chamber 262 through the suction passage 265 in the outer periphery of the hollow pipe 261.

Further, the vehicle height adjusting apparatus 150 is provided with a blow passage 272 piercing the damper tube 211 and leading the discharge passage 263 between the pump chamber 262 of the hydraulic pump 260 and the jack chamber 154 of the hydraulic jack 151 to the piston side oil chamber 225B in the damper tube 211 via an annular valve chamber 271 which is defined by the end housing 215 of the second hydraulic shock absorber 210 and the outer periphery of the damper tube 211, as shown in FIGS. 15 and 17. The blow valve 270 is mounted in the valve chamber 271 of the end housing 215, is seated on a seat surface to which the discharge passage 263 of the valve chamber 271 is open, and opens and closes the blow passage 272. The blow valve 270 is biased in a closing direction by biasing means 273 constructed by a coil spring forming a biasing spring 213 which is interposed between the spring receiver 218 supported on the blow valve 270 and the spring receiver 219 provided in the piston rod 212. The valve opening pressure Pb mentioned above of the blow valve 270 is determined depending on the biasing means 273, and varies as shown in FIG. 18 as a spring length of the biasing means 273 of the second hydraulic shock absorber 210 is changed in response to the damper sagging stroke St mentioned above due to the extension and retraction of the first hydraulic shock absorber 110.

According to the present embodiment, the following operations and effects can be achieved.

(a) In a range in which the spring load on the suspension spring 113 of the first hydraulic shock absorber 110 is reduced by unloading goods from the vehicle in the standard vehicle height state, for example, the damper (the hydraulic shock absorber 110) is extended, the damper sagging stroke St corresponding to the amount of displacement from the extending end of the piston rod 112 of the first hydraulic shock absorber 110 becomes small, and the vehicle height becomes higher than the standard vehicle height, it is set such that the jack pressure Pa of the first hydraulic shock absorber 110 becomes smaller and the valve opening pressure Pb of the blow valve 270 of the second hydraulic shock absorber 210 becomes smaller than the jack pressure Pa as the vehicle height becomes higher. At this time, if the second hydraulic shock absorber 210 is excited by the irregularity of the road surface while the vehicle travels, and the hydraulic pump 260 of the second hydraulic shock absorber 210 carries out the pumping action, the jack pressure Pa which the hydraulic pump 260 feeds to the hydraulic jack 151 of the first hydraulic shock absorber 110 is released by opening the blow valve 270 of the second hydraulic shock absorber 210, and the vehicle height is brought down to the standard vehicle height.

(b) In a range in which the spring load on the suspension spring 113 of the first hydraulic shock absorber 110 is increased by loading goods to a vehicle in the standard vehicle height state, for example, the damper sags, the damper sagging stroke St of the first hydraulic shock absorber 110 becomes large, and the vehicle height becomes lower than the standard vehicle height, it is set such that the jack pressure Pa of the first hydraulic shock absorber 110 becomes larger, and the valve opening pressure Pb of the blow valve 270 of the second hydraulic shock absorber 210 becomes larger than the jack pressure Pa as the vehicle height becomes lower. At this time, if the second hydraulic shock absorber 210 is excited by the irregularity of the road surface while the vehicle travels, and the hydraulic pump 260 of the second hydraulic shock absorber 210 carries out the pumping action, the release of the jack pressure Pa which the hydraulic pump 260 feeds to the hydraulic jack 151 of the first hydraulic shock absorber 110 is stopped by closing the blow valve 270 of the second hydraulic shock absorber 210, and the vehicle height is brought up to the standard vehicle height.

(c) According to the vehicle height adjusting apparatus 150 having the simple and compact structure in which the jack pressure Pa of the hydraulic jack 151 of the first hydraulic shock absorber 110 and the valve opening pressure Pb of the blow valve 270 of the second hydraulic shock absorber 210 are set so as to satisfy the relationships (a) and (b) mentioned above with respect to the damper sagging stroke St, the vehicle height can be controlled to be always at a fixed value regardless of the spring load on the suspension spring 113 of the first hydraulic shock absorber 110.

(d) The second hydraulic shock absorber 210 described in the above (a) to (c) has the blow valve 270 releasing the jack pressure Pa in the jack chamber 154 which is pressurized by the plunger 155 of the hydraulic jack 151 exposed to the spring load on the suspension spring 113 in the first hydraulic shock absorber 110. In this case, the blow valve 270 of the second hydraulic shock absorber 210 is provided in the end housing 215 of the damper tube 211 in such a manner as to open and close the blow passage 272 which is formed in the end housing 215 and leads the discharge passage 263 between the pump chamber 262 and the jack chamber 154 of the first hydraulic shock absorber 110 to the oil chamber 225B in the damper tube 211, and is biased in the closing direction by the biasing means 273 (the biasing spring 213) interposed between the blow valve 270 and the piston rod 212. Accordingly, it is possible to control the vehicle height to be always at a fixed value regardless of the spring load on the suspension spring 113 of the first hydraulic shock absorber 110, according to the simple and compact structure in which the spring characteristic of the suspension spring 113 pushing down the plunger 155 of the hydraulic jack 151 of the first hydraulic shock absorber 110 and the spring characteristic of the biasing means 273 (the biasing spring 213) biasing the blow valve 270 of the second hydraulic shock absorber 210 in the closing direction are set in such a manner that the jack pressure Pa of the hydraulic jack 151 of the first hydraulic shock absorber 110 and the valve opening pressure Pb of the blow valve 270 of the second hydraulic shock absorber 210 satisfy the relationships (a) and (b) mentioned above with respect to the damper sagging stroke.

### Embodiment 4

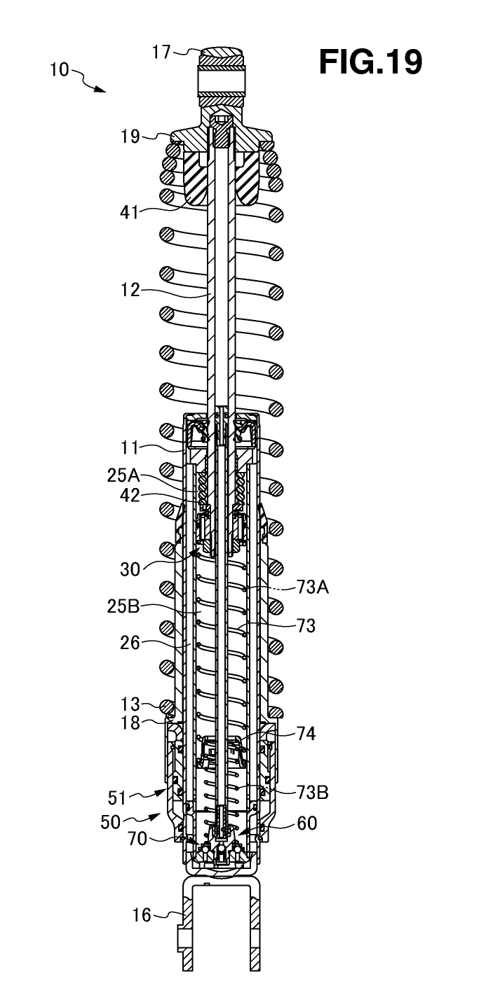

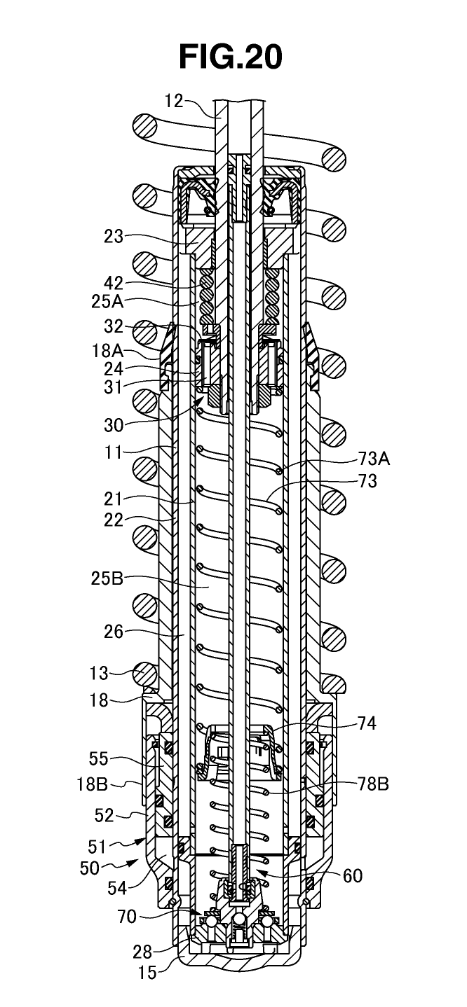

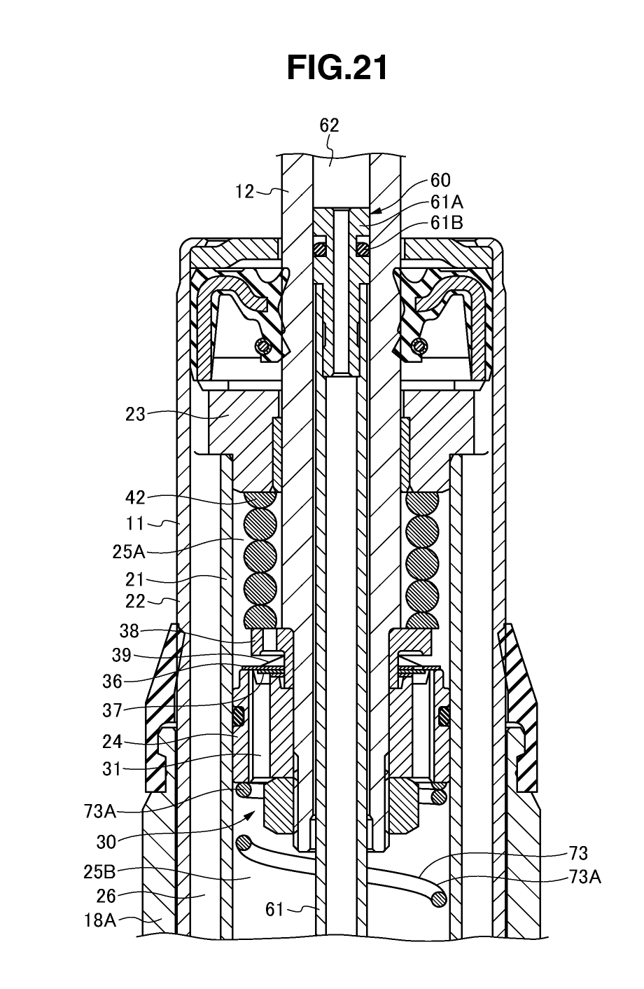

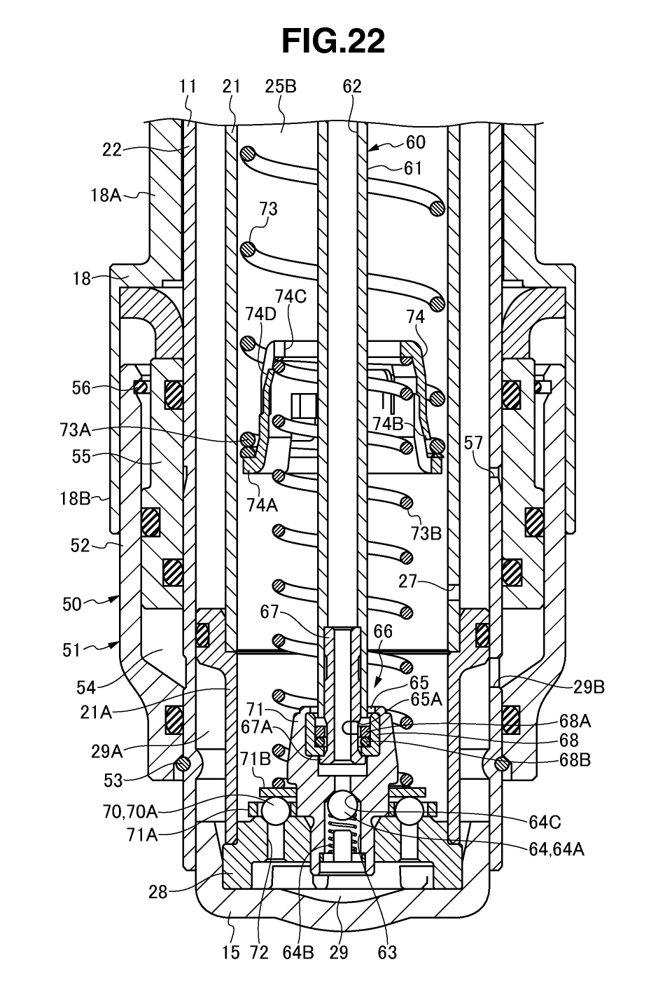

### FIGS. 19 to 23

FIGS. 19 to 23 show a hydraulic shock absorber according to an embodiment 4, and the same reference numerals are attached to members which are substantially the same as those of the embodiments 1 and 2. A hydraulic shock absorber 10 according to the embodiment 4 is substantially different from the hydraulic shock absorber 10 according to the embodiment 1, in structures of a pump chamber 62, a discharge passage 63 and a discharge check valve 64 of a hydraulic pump 60, structures of a suction passage 65 and a suction check valve 66, and structures of a blow valve 70 and a biasing means 73 thereof.

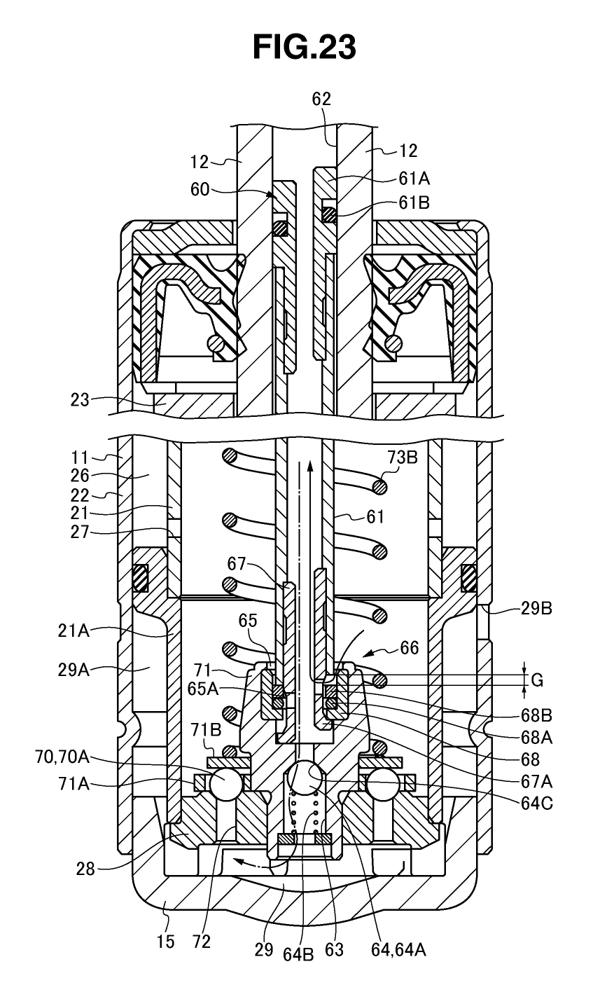

In the hydraulic pump 60, a hollow seal case 61A is fitted and fixed to an upper end portion of a hollow pipe 61, and a hollow valve body 67 of the suction check valve 66 is fitted and fixed to a lower end portion of the hollow pipe 61. A packing case 68 is attached to the lower end portion of the hollow pipe 61, and a periphery of a portion which protrudes from the lower end portion of the hollow pipe 61 in the valve body 67. A packing 68A and a backup ring 68B loaded to an inner periphery of the packing case 68 are fixedly stored on a lower end flange portion of the packing case 68 as a sub assembly. The sub assembly of the packing case 68, the packing 68A and the backup ring 68B is loosely inserted to the periphery of the protruding portion with respect to the hollow pipe 61 of the valve body 67, and is retained by an extended stopper portion 67A provided in an outer periphery of a protruding end of the valve body 67. A total length in an axial direction of the lower end flange portion, the packing 68A and the backup ring 68B of the packing case 68 is made only at a fixed length G (FIG. 23) shorter than a distance formed by the lower end surface of the hollow pipe 61 and the stopper portion 67A of the valve body 67. Accordingly, the sub assembly of the packing case 68, the packing 68A and the backup ring 68B can move in an axial direction only at a fixed length G around the protruding portion of the valve body 67. The sub assembly of the packing case 68, the packing 68A and the backup ring 68B which are loosely inserted to the periphery of the protruding portion of the valve body 67 is fitted to a center hole of a valve stopper 71 for the blow valve 70 which is fixed to the center of an end piece 28 of a damper tube 11 so as to be sealed. The lower end portion of the hollow pipe 61 is provided in a rising manner so as to be movable up and down at the fixed length G mentioned above with respect to the packing case 68 which is sealed to the valve stopper 71. The upper end portion of the hollow pipe 61 is slidably inserted to the hollow portion of a piston rod 12 via a seal member 61B provided in an outer peripheral annular groove of the seal case 61A.

The hydraulic pump 60 forms the pump chamber 62 by the hollow portion of the piston rod 12 and the hollow portion of the hollow pipe 61, and forms the discharge passage 63 in the valve stopper 71, and the discharge check valve 64 is provided in the discharge passage 63. The discharge check valve 64 presses a ball valve 64A loaded within the discharge passage 63 of the valve stopper 71 to a valve seat 64C formed in the valve stopper 71 by a coil spring 64B, moves the ball valve 64A away from the valve seat 64C by pressurizing the pump chamber 62 so as to open, and makes the ball valve 64A seat on the valve seat 64C at a time of a negative pressure of the pump chamber 62 so as to close. In this case, a partition wall collar 21A provided in a lower end portion of an inner tube 21 pinches and fixes the end piece 28 with respect to an inner surface of a bottom cup 15, and a communication passage 29A communicating a communication passage 29, to which the discharge passage 63 of the hydraulic pump 60 is open, with a side of a jack chamber 54 of a hydraulic jack 51 is formed among the partition wall collar 21A, the bottom cup 15 and an outer tube 22.

The hydraulic pump 60 forms an upper end opening portion which normally faces to a piston side oil chamber 25B of the packing case 68 sealed to the valve stopper 71 as the suction passage 65, and a hole-like suction port 65A of the suction check valve 66 is pierced in a valve body 67 which is loosely inserted to the sub assembly of the packing case 68, the packing 68A and the backup ring 68B movable in an axial direction. At this time, the suction port 65A is open to the piston side oil chamber 25B within the damper tube 11, and is arranged at the lower position than the lower end portion of the piston rod 12 in the maximum compression state with respect to the damper tube 11, in the lower end side of the hollow pipe 61.

The hydraulic pump 60 constitutes the suction check valve 66 by the hollow pipe 61, the valve body 67, and the packing 68A and the backup ring 68B which are stored in the packing case 68. If a negative pressure is applied to the end surface of the seal case 61A in the upper end portion of the hollow pipe 61, at a time of the negative pressure of the pump chamber 62, the hollow pipe 61 and the valve body 67 move upward at the fixed length G with respect to the packing case 68 which is sealed to the valve stopper 71, and open the suction port 65A of the suction check valve 66 provided in the valve body 67 with respect to the piston side oil chamber 25B via the suction passage 65 of the packing case 68 (a right half portion in FIG. 23). When the pump chamber 62 is pressurized, the pressurizing force is applied to the end surface of the seal case 61A in the upper end portion of the hollow pipe 61, the hollow pipe 61 and the valve body 67 move downward at the fixed length G with respect to the packing case 68, the lower end surface of the hollow pipe 61 strikes against the backup ring 68B within the packing case 68 so as to shut off the suction passage 65 of the packing case 68 guiding the suction port 65A of the suction check valve 66 provided in the valve body 67 to the piston side oil chamber 25B, and the suction port 65A is closed with respect to the piston side oil chamber 25B (a left half portion in FIG. 23).

Accordingly, the hydraulic pump 60 carries out a pumping motion on the basis of an extension and retraction motion in which the vehicle travels and the hydraulic shock absorber 10 is excited by an irregularity on a road surface, and the piston rod 12 moves forward and backward to the damper tube 11 and the hollow pipe 61. When the pump chamber 62 is pressurized on the basis of the pumping motion caused by the compressing motion of the piston rod 12, the oil in the pump chamber 62 opens the discharge check valve 64 so as to be discharged to the side of the hydraulic jack 51 from the discharge passage 63 of the valve stopper 71. If the pump chamber 62 comes to the negative pressure on the basis of the pumping motion caused by the extending motion of the piston rod 12, the oil in the piston rod side oil chamber 25A of the damper tube 11 opens the suction check valve 66 so as to be sucked into the pump chamber 62 from the suction passage 65 of the packing case 68.

The blow valve 70 is constructed by a plurality of ball valves 70A, loads the respective ball valves 70A into a plurality of holes provided in a retainer plate 71A which is loosely inserted to an outer periphery of the valve stopper 71 provided in the end piece 28, and makes the lower surfaces of the respective ball valves 70A seat on a plurality of blow passages 72 provided in the end piece 28. Each of the ball valves 70A of the blow valve 70 is biased in a closing direction by the biasing means 73 constructed by a coil spring, via a washer 71B provided in an outer periphery of the valve stopper 71. A valve opening pressure Pb of each of the ball valves 70A of the blow valve 70 is decided in the same manner as that in the embodiment 1.

The biasing means 73 is constructed by an upper coil spring 73A having a large coil diameter and a lower coil spring 73B having a small coil diameter, in the same manner as the embodiment 2. A lower end of the upper coil spring 73A is loaded to an outer peripheral portion of a spring joint 74, an upper end of the lower coil spring 73B is loaded to an inner peripheral portion of the spring joint 74, an upper end of the upper coil spring 73A is supported by a face which faces to the piston side oil chamber 25B of a piston 24 provided in the piston rod 12, and a lower end of the lower coil spring 73B is supported by the washer 71B on each of the ball valves 70A of the blow valve 70. As a result, each of the ball valves 70A of the blow valve 70 is biased in a closing direction by a combined spring force of the upper coil spring 73A and the lower coil spring 73B. Since a lower end of the upper coil spring 73A and an upper end of the lower coil spring 73B are loaded to inner and outer peripheries of the spring joint 74, it is possible to overlap the lower end and the upper end approximately at a length of the spring joint 74 in an axial direction so as to make a storage length of the upper coil spring 73A and the lower coil spring 73B within a distance length between the piston 24 of the piston rod 12 and the blow valve 70 longer at the overlapping length, and it is possible to improve a spring characteristic of the coil springs 73A and 73B biasing the blow valve 70. The spring joint 74 can be constructed in the same manner as that in the embodiment 2 (FIGS. 10A and 10B).

In this case, in the hydraulic shock absorber 10 according to the embodiment 4, in the same manner as that in the embodiment 2, a spring receiver 18 is provided with a spring guide 18A, and is provided with the dust seal 18B so as to be extended to cover the outer peripheries of a jack housing 52 and a plunger 55.

Further, in the hydraulic shock absorber 10 according to the embodiment 4, in the same manner as that in the embodiment 2, a piston valve apparatus 30 is provided in a piercing manner with an oil path 31 communicating the piston rod side oil chamber 25A with the piston side oil chamber 25B in the piston 24, and is provided with a perforated valve 36 which opens and closes the opening to the oil chamber 25A in the oil path 31, and a disc valve 37 which is additionally provided in the perforated valve 36 so as to close the hole of the perforated valve 36 from the side of the oil path 31. The extension side damping force is generated by deflection deforming the disc valve 37 on the basis of the oil pressure of the oil chamber 25A passing through the hole of the perforated valve 36 so as to push open, at the extending time, and the compression side damping force is generated by sliding the perforated valve 36 and the disc valve 37 on the basis of the oil pressure of the oil chamber 25B so as to push open, when compressed. Reference numeral 38 denotes a valve stopper for the perforated valve 36, and reference numeral 39 denotes a valve spring.

Further, in the hydraulic shock absorber 10 according to the embodiment 4, in the same manner as that in the embodiment 2, an extension side shock absorbing rubber 42 in the embodiment 1 is replaced by an extension side shock absorbing spring 42.

According to the embodiment, in addition to the operations and effects in the embodiments 1 and 2, the following operations and effects can be achieved.

If the hydraulic shock absorber 10 is vertically placed or the vehicle body is raised up, after the hydraulic shock absorber 10 is horizontally stored, or inverted together with the vehicle body, and the above air of an oil reservoir chamber 26 intrudes into the oil chambers 25A and 25B, the intruding air gets together in the lower portion of the piston 24 within the oil chambers 25A and 25B. The air moves to the upper portion of the piston 24 through oil paths 31A and 31B of the piston 24 on the basis of the extension and retraction of the hydraulic shock absorber 10, and is discharged to the oil reservoir chamber 26 from the sliding gap between the piston rod 12 and a rod guide 23.

On the other hand, the suction port 65A of the hydraulic pump 60 is arranged at the lower position than the lower end portion of the piston rod 12 when the damper is maximum compressed, in the lower end side of the hollow pipe 61, and is always submerged in the oil. Accordingly, it is possible to exclude the chance that the air intruding into the oil chambers 25A and 25B of the hydraulic shock absorber 10 is sucked into the suction port 65A of the hydraulic pump 60, and it is possible to prevent the air from being sucked into the pump chamber 62. It is possible to stably pressure feed the oil in the pump chamber 62 to the hydraulic jack 51 on the basis of the pumping motion of the hydraulic pump 60 going with the extension and retraction of the hydraulic shock absorber 10.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention.

The present invention relates to the vehicle height adjusting apparatus of a hydraulic shock absorber, and has the hydraulic pump which carries out the pumping action by the extending and retracting motion of the piston rod with respect to the damper tube so as to feed the working fluid to the jack chamber of the hydraulic jack, and the blow valve which releases the jack pressure of the jack chamber pressurized by the plunger of the hydraulic jack exposed to the spring load on the suspension spring, in which it is set such that in the range in which the damper sagging stroke corresponding to the amount of displacement from the expending end of the piston rod is small and the vehicle height is high, the jack pressure becomes smaller and the valve opening pressure of the blow valve becomes smaller than the jack pressure as the vehicle height becomes higher, whereby the blow valve is opened to release the jack pressure which the hydraulic pump feeds to the hydraulic jack so as to bring down the vehicle height, and it is set such that in the range in which the damper sagging stroke is large and the vehicle height is low, the jack pressure becomes larger and the valve opening pressure of the blow valve becomes larger than the jack pressure as the vehicle height becomes lower, whereby the blow valve is closed to stop the release of the jack pressure which the hydraulic pump feeds to the hydraulic jack so as to bring up the vehicle height. Accordingly, it is possible to compactly construct the vehicle height adjusting apparatus of a hydraulic shock absorber which is provided between the vehicle body and the axle to attenuate the oscillation from the road surface, and control the vehicle height to be always at a fixed value regardless of the spring load on the suspension spring.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A vehicle height adjusting apparatus of a hydraulic shock absorber comprising:
a damper tube provided on one of a vehicle body side and an axle side;
a piston rod provided on the other of the vehicle body side and the axle side, and sliding along an oil chamber within the damper tube so as to extend and retract with respect to the damper tube;
a hydraulic jack provided in one of a damper tube and a piston rod; and
a suspension spring interposed between a spring receiver supported by a plunger inserted into a jack chamber of the hydraulic jack and a spring receiver provided in the other of the damper tube and the piston rod;
a hydraulic pump carrying out a pumping action by an extending and retracting motion of the piston rod with respect to the damper tube so as to feed a working fluid to the jack chamber of the hydraulic jack; and
a blow valve releasing a jack pressure of the jack chamber pressurized by the plunger of the hydraulic jack exposed to a spring load on the suspension spring;
wherein in a range in which a damper sagging stroke corresponding to an amount of displacement from an extending end of the piston rod is small and a vehicle height is high, it is set such that the jack pressure becomes smaller and a valve opening pressure of the blow valve becomes smaller than the jack pressure as the vehicle height becomes higher, whereby the blow valve is opened to release the jack pressure which the hydraulic pump feeds to the hydraulic jack so as to bring down the vehicle height; and
in a range in which the damper sagging stroke is large and the vehicle height is low, it is set such that the jack pressure becomes larger and the valve opening pressure of the blow valve becomes larger than the jack pressure as the vehicle height becomes lower, whereby the blow valve is closed to stop the release of the jack pressure which the hydraulic pump feeds to the hydraulic jack so as to bring up the vehicle height.

2. The vehicle height adjusting apparatus of a hydraulic shock absorber according to claim 1, wherein the hydraulic shock absorber is provided with an end piece which comparts the oil chamber within the damper tube and the jack chamber of the hydraulic jack, in a bottom portion of the damper tube, and has the hydraulic pump and the blow valve in the damper tube,
wherein the hydraulic pump comprises a hollow pipe provided in a rising manner in the end piece of the damper tube slidably inserted to a hollow portion of the piston rod, a pump chamber formed by the hollow portion of the piston rod and the hollow pipe, a discharge check valve in a discharge passage discharging the working fluid in the pump chamber pressurized by a retraction motion of the piston rod to a side of the hydraulic jack, and a suction check valve in a suction passage sucking the working fluid in the oil chamber within the damper tube to the pump chamber which comes to a negative pressure on the basis of an extension motion of the piston rod, and
wherein the blow valve is provided on the end piece so as to open and close a blow passage which is formed in the end piece of the damper tube and guides the discharge passage between the pump chamber and the jack chamber to the oil chamber within the damper tube, and is biased in a closing direction by biasing means which is interposed between the blow valve and the piston rod.

3. The vehicle height adjusting apparatus of a hydraulic shock absorber according to claim 2, wherein the hydraulic pump arranges a suction port which is open to the oil chamber within the damper tube at a lower position than a lower end portion of the piston rod at the damper maximum compression time, in a lower end side of the hollow pipe.

4. A vehicle height adjusting apparatus comprising a first hydraulic shock absorber and a second hydraulic shock absorber arranged in parallel,
the first hydraulic shock absorber comprising:
a damper tube provided in one of a vehicle body side and an axle side;
a piston rod provided in the other of the vehicle body side and the axle side, and sliding along an oil chamber within the damper tube so as to extend and retract with respect to the damper tube;
a hydraulic jack provided in one of a damper tube and a piston rod; and
a suspension spring interposed between a spring receiver supported by a plunger inserted into a jack chamber of the hydraulic jack and a spring receiver provided on the other side of the damper tube and the piston rod,
the second hydraulic shock absorber comprising:
a damper tube provided on one of the vehicle body side and the axle side;
a piston rod provided in the other of the vehicle body side and the axle side, and sliding along the oil chamber within the damper tube so as to extend and retract with respect to the damper tube;
a hydraulic pump carrying out a pumping action by an extending and retracting motion of the piston rod with respect to the damper tube so as to feed a working fluid to the jack chamber in the hydraulic jack of the first hydraulic shock absorber; and
a blow valve releasing the jack pressure of the jack chamber which is pressurized by the plunger of the hydraulic jack exposed to the spring load on the suspension spring in the first hydraulic shock absorber,
wherein in a range in which a damper sagging stroke corresponding to an amount of displacement from an extending end of the piston rod of the first hydraulic shock absorber is small and a vehicle height is high, it is set such that the jack pressure of the first hydraulic shock absorber becomes smaller and a valve opening pressure of the blow valve of the second hydraulic shock absorber becomes smaller than the jack pressure as the vehicle height becomes higher, whereby the blow valve is opened to release the jack pressure which the hydraulic pump of the second hydraulic shock absorber feeds to the hydraulic jack of the first hydraulic shock absorber so as to bring down the vehicle height, and
in a range in which the damper sagging stroke of the first hydraulic shock absorber is large and the vehicle height is low, it is set such that the jack pressure of the first hydraulic shock absorber becomes larger and the valve opening pressure of the blow valve of the second hydraulic shock absorber becomes larger than the jack pressure as the vehicle height becomes lower, whereby the blow valve is closed to stop the release of the jack pressure which the hydraulic pump of the second hydraulic shock absorber feeds to the hydraulic jack of the first hydraulic shock absorber so as to bring up the vehicle height.

5. The vehicle height adjusting apparatus according to claim 4, wherein the second hydraulic shock absorber is structured such that an end housing is attached to an end portion of the damper tube, and has the hydraulic pump and the blow valve built-in in the damper tube,
the hydraulic pump is a slidably inserted hollow pipe provided upright in the end housing of the damper tube to a pump chamber formed by a hollow portion of the piston rod, and has a discharge check valve provided in a discharge passage discharging the working fluid in the pump chamber, pressurized due to a retracting motion of the piston rod, to a side of the hydraulic jack of the first hydraulic shock absorber, and a suction check valve provided in a suction passage sucking the working fluid in the damper tube to the pump chamber becoming a negative pressure as a result of an extending motion of the piston rod, and
the blow valve is provided in the end housing in such a manner as to open and close a blow passage which is formed in the end housing of the damper tube and leads the discharge passage between the pump chamber and the jack chamber of the first hydraulic shock absorber to the oil chamber in the damper tube, and is biased in a closing direction by biasing means interposed between the blow valve and the piston rod.

6. The vehicle height adjusting apparatus according to claim 1, wherein the damper tube is provided with an oil return passage returning the working fluid in the jack chamber into the damper tube, when the plunger reaches a protruding end protruding from the jack chamber based on the working fluid fed to the jack chamber of the hydraulic jack.

7. The vehicle height adjusting apparatus according to claim 2, wherein the damper tube is provided with an oil return passage returning the working fluid in the jack chamber into the damper tube, when the plunger reaches a protruding end protruding from the jack chamber based on the working fluid fed to the jack chamber of the hydraulic jack.

8. The vehicle height adjusting apparatus according to claim 3, wherein the damper tube is provided with an oil return passage returning the working fluid in the jack chamber into the damper tube, when the plunger reaches a protruding end protruding from the jack chamber based on the working fluid fed to the jack chamber of the hydraulic jack.

9. The vehicle height adjusting apparatus according to claim 4, wherein the damper tube is provided with an oil return passage returning the working fluid in the jack chamber into the damper tube, when the plunger reaches a protruding end protruding from the jack chamber based on the working fluid fed to the jack chamber of the hydraulic jack.

10. The vehicle height adjusting apparatus according to claim 5, wherein the damper tube is provided with an oil return passage returning the working fluid in the jack chamber into the damper tube, when the plunger reaches a protruding end protruding from the jack chamber based on the working fluid fed to the jack chamber of the hydraulic jack.
